(19) United States
(12) Patent Application Publication
(10) Pub. No.: US 2026/0111272 A1
(43) Pub. Date: Apr. 23, 2026

(54) COORDINATED AUTO-SCALING OF SERVERLESS FUNCTIONS AND ELASTIC STREAMS

(71) Applicant: Dell Products L.P., Round Rock, TX (US)

(72) Inventor: Raúl Gracia-Tinedo, Barcelona (ES)

(21) Appl. No.: 18/920,171

(22) Filed: Oct. 18, 2024

(51) Int. Cl. G06F 9/50; G06F 9/52

(52) U.S. Cl. CPC G06F 9/5027; G06F 9/52

(57) ABSTRACT

A method for managing a data stream processing pipeline includes: monitoring data stream ingestion of a system and a computing resource utilization value (CRUV) of each of a first serverless function (SF), a second SF, and a third SF to obtain a set of metrics; analyzing the set of metrics based on a policy; making a determination that the data stream ingestion exceeds a first threshold and the CRUV of the third SF exceeds a second threshold; in response to the determination: initiating scaling up of a first number of stream segments of a data stream associated with the second stage; and initiating scaling up of a second number of SFs associated with the second stage to reduce the CRUV of the third SF, in which the scaling up of the second number of SFs is achieved by deploying a fourth SF to the second stage.

### BACKGROUND

Streaming applications are applications that deal with a large amount of data arriving continuously. In processing streaming application data, the data can arrive late, arrive out of order, and the processing can undergo failure conditions. It can be appreciated that tools designed for previous generations of big data applications may not be ideally suited to process and store streaming application data.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1.1 shows a diagram of a system in accordance with one or more embodiments disclosed herein.

FIG. 1.2 shows a diagram of a streaming storage system in accordance with one or more embodiments.

FIG. 2.1 shows a scenario about how an orchestrator manages coordinated and dynamic auto-scaling of serverless functions and elastic streams in serverless function pipelines in accordance with one or more embodiments disclosed herein.

FIG. 2.2 shows an example programmatic framework in accordance with one or more embodiments disclosed herein.

FIG. 3 shows a method for managing a data stream processing pipeline in accordance with one or more embodiments disclosed herein.

FIG. 4 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In recent years, serverless computing (e.g., the Function-as-a-Service (FaaS) paradigm) is becoming an increasingly popular approach for users (e.g., administrators, data scientists, etc.) to execute computations on large datasets (e.g., Azure Functions, AWS Lambda, etc.). In most cases, the main difference between conventional dataflow analytics and serverless computing (or FaaS) is related to resource management: that is, executing dataflow analytics (e.g., via systems such as Apache Flink, Apache Spark, etc.) requires users to decide/reason about correct-sizing the underlying cluster that will be executing analytics jobs based on the expected workload.

Conversely, in the serverless computing (or in the FaaS paradigm/model), users may just concentrate on the function (that needs to be executed) and the target dataset, while the remaining elements of the computing process may be agnostic to the infrastructure (e.g., the FaaS platform/system). At the background, the FaaS platform may take care of instantiating/initiating the correct number of functions according to the partitioning of a related input dataset. This may also translate into a simpler programming paradigm (including, for example, simple application programming interfaces (APIs), an imperative code style, etc.) that has a high potential to increase the adoption of cloud computing by non-advanced users.

Recent examples of streaming storage services (as a storage substrate for data-intensive serverless functions) may be a good fit for leveraging efficient serverless function pipelining. However, in this scenario, the problem of how to coordinate the inherent scalability of FaaS systems with the number of stream partitions remains unaddressed. More specifically, (i) how can a user align the parallelism of serverless functions and data streams and (ii) how can a user keep a coordinated notion of auto-scaling between data streams and serverless functions.

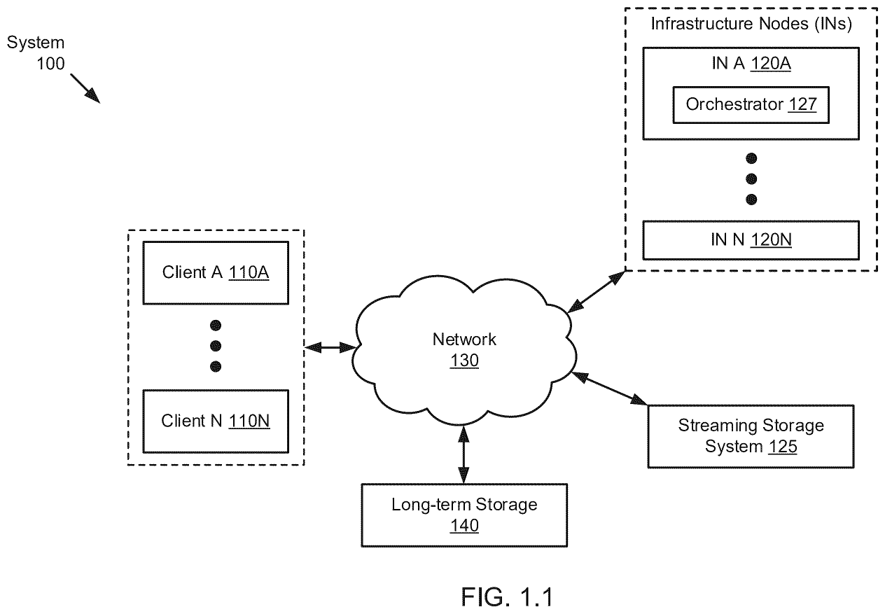

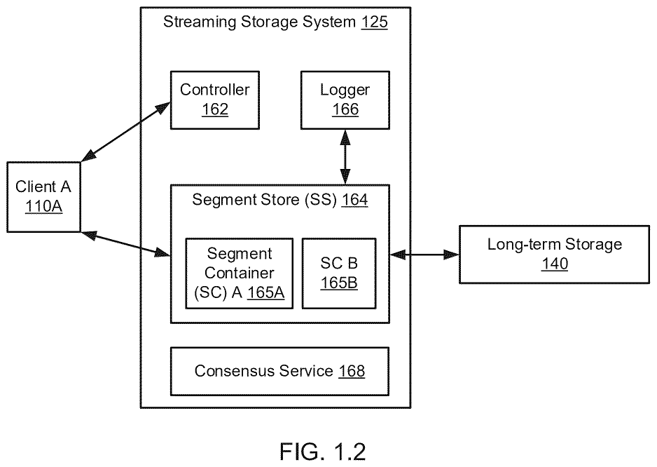

For at least the reasons discussed above and without requiring resource (e.g., time, engineering, etc.) intensive efforts, a fundamentally different approach is needed (e.g., a framework for solving the problem of coordinating the inherent auto-scaling of FaaS systems (e.g., serverless functions) with the parallelism of data streams, by exploiting the properties of elastic streams managed by a streaming storage system/service (e.g., 125, FIG. 1.1) that can dynamically change the number of parallel stream partitions (for correct-sizing this number to the number of serverless functions consuming from that data stream)).

Embodiments disclosed herein relate to methods and systems for managing a data stream processing pipeline (or managing serverless function pipelining). As a result of the processes discussed below, one or more embodiments disclosed herein advantageously ensure that (at least, for example, for a better user experience): (i) the framework provides/enables a programmatic abstraction for users (e.g., FaaS users, serverless function users/people, etc.) to use data streams (or stream data) as an input/output (I/O) channel (e.g., in order to allow a FaaS user/programmer (a) for building some code for a serverless function so that the function can consume data and (b) for executing serverless functions using data streams); (ii) with the help of the programmatic abstraction, the framework keeps metrics about the processing performance of FaaS functions (or serverless functions) in a fine-grained manner (e.g., so that a user can act on individual functions, if needed, by scaling up or scaling down the number of functions); (iii) the framework exposes one or more policies to users/administrators so that users can define a correct approach (e.g., a user-defined “scaling” policy/approach) in which both serverless functions and data streams are auto-scaled; (iv) the framework includes an orchestrator (e.g., 127, FIG. 1.1) that monitors serverless functions and data streams, and, as a result of the monitoring, takes coordinated auto-scaling decisions (for the functions and/or streams (or stream segments)) based on real-time (or near real-time) metrics and user-defined policies; (v) the framework coordinates auto-scaling of serverless functions with the streaming storage system (including/managing elastic data streams); (vi) the framework is suitable/relevant for all types of FaaS systems (e.g., cloud or on-premise FaaS systems in which serverless functions can access external services, such as messaging/streaming storage systems and object stores) that allow the orchestration of serverless functions; and/or (vii) the framework uses streaming storage systems/services as a data-intensive I/O (e.g., read/write) channel for FaaS functions (or serverless functions).

The following describes various embodiments disclosed herein.

FIG. 1.1 shows a diagram of a system (100) in accordance with one or more embodiments disclosed herein. The system (100) includes any number of clients (e.g., Client A (110A), Client N (110N), etc.), any number of infrastructure nodes (INs) (e.g., IN A (120A), IN N (120N), etc.), a long-term storage (140) (e.g., a tier-2 storage), a streaming storage system (125), and a network (130). The system (100) may facilitate the management of “stream” data from any number of sources (e.g., 110A, 110N, etc.). The system (100) may include additional, fewer, and/or different components without departing from the scope of the embodiments disclosed herein. Each component may be operably connected to any of the other components via any combination of wired and/or wireless connections. Each component illustrated in FIG. 1.1 is discussed below.

In one or more embodiments, the clients (e.g., 110A, 110N, etc.), the INs (e.g., 120A, 120N, etc.), the long-term storage (140), the streaming storage system (125), and the network (130) may be (or may include) physical or logical devices, as discussed below. While FIG. 1.1 shows a specific configuration of the system (100), other configurations may be used without departing from the scope of the embodiments disclosed herein. For example, although the clients (e.g., 110A, 110N, etc.) and IN A (120A) are shown to be operatively connected through a communication network (e.g., 130), the clients (e.g., 110A, 110N, etc.) and IN A (120A) may be directly connected (e.g., without an intervening communication network).

Further, functioning of the clients (e.g., 110A, 110N, etc.) and the INs (e.g., 120A, 120N, etc.) is not dependent upon the functioning and/or existence of the other components (e.g., devices) in the system (100). Rather, the clients and the INs may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data) (including multiple events, each of which is associated with a routing key) that are continuously produced by streaming data sources (e.g., writers, clients, etc.), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

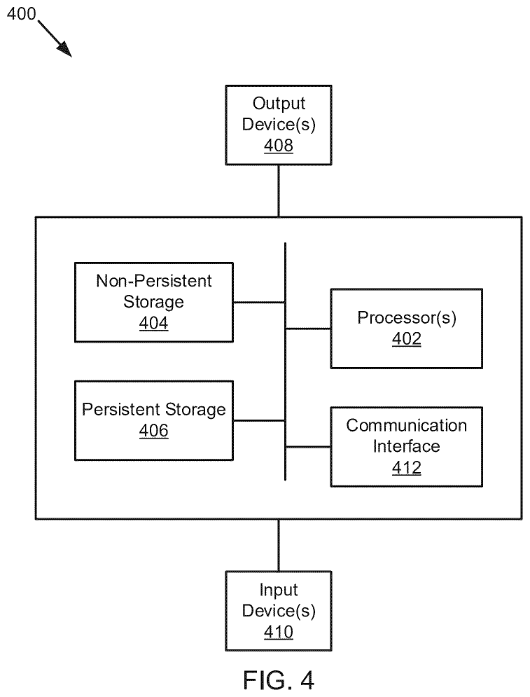

In one or more embodiments, the system (100) may be a distributed system (e.g., a data processing environment for processing streaming application data) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). For example, the system may be configured to organize unbounded, continuously generated data into a data stream (described below in reference to FIG. 1.2) that may be auto-scaled based on individual segment loading. The system (100) may also represent a comprehensive middleware layer executing on computing devices (e.g., 400, FIG. 4) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the INs (e.g., 120A, 120N, etc.)) from the users. By doing so, the users may utilize different computing devices (e.g., 400, FIG. 4) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the INs (e.g., 120A, 120N, etc.)), store, or otherwise utilize captured sensor data (and/or any other type and/or quantity of data), and/or (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the INs (e.g., 120A, 120N, etc.). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, sensor data may be implemented as, for example, a list. Each entry of the list may include information representative of, for example, (i) periods of time and/or points-in-time associated with when a portion of sensor data included in the entry was obtained and/or (ii) the portion of sensor data. The sensor data may have different organizational structures without departing from the scope of the embodiments disclosed herein. For example, the sensor data may be implemented as a tree, a table, a linked list, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or computing device operated by one or more individuals of (or employed by) an organization. Examples of said individual(s) may include, but not limited to, any organization executive(s) (e.g., chief executive officer (CEO), chief financial officer (CFO), etc.) and any employee(s) in the data management team of the organization (e.g., an administrator). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the INs (e.g., 120A, 120N, etc.). For example, the clients may issue requests to an IN (e.g., 120A) to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by an IN (e.g., 120A). When the clients interact with the IN, data that is relevant to the clients may be stored (temporarily or permanently) in the IN.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with the INs (e.g., 120A, 120N, etc.) that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by an IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high-speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the INs (e.g., 120A, 120N, etc.)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be taken into account without departing from the scope of the embodiments disclosed herein.

Further, in one or more embodiments, a client (e.g., 110A, 110N, etc.) may be implemented as a computing device (e.g., 400, FIG. 4). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user/person/human with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 400, FIG. 4) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, an IN (e.g., 120A) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, an IN (e.g., 120A) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the long-term storage (140) (discussed below in reference to FIG. 1.2) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (e.g., 120N) for review and/or other human interactions; (x) exchange data with other devices registered in/to the network (130) in order to, for example, participate in a collaborative workload placement (e.g., the node may split up a request (e.g., an operation, a task, an activity, etc.) with another node (e.g., 120N), coordinating its efforts to complete the request more efficiently than if the node had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the long-term storage (140); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or long-term storage; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (e.g., 120A) may communicate with, for example, the long-term storage (140) and/or other storage devices in the system (100).

In one or more embodiments, monitoring operational states of the clients (e.g., 110A, 110N, etc.) may be used to determine whether it is likely that the monitoring of the scenes by the clients results in information regarding the scenes that accurately reflects the states of the scenes (e.g., a client may provide inaccurate information regarding a monitored scene). Said another way, by providing monitoring services, an IN (e.g., 120A) may be able to determine whether a client is malfunctioning (e.g., the operational state of a client may change due to a damage to the client, malicious action (e.g., hacking, a physical attack, etc.) by third-parties, etc.). If the client is not in the predetermined operational state (e.g., if the client is malfunctioning), the IN may take action to remediate the client. Remediating the client may result in the client being placed in the predetermined operational state which improves the likelihood that monitoring of the scene by the client results in the generation of accurate information regarding the scene.

As described above, an IN (e.g., 120A) of the INs may be capable of providing a range of functionalities/services to the users of the clients (e.g., 110A, 110N, etc.). However, not all of the users may be allowed to receive all of the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (e.g., 120A) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (e.g., 120A) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high-priority user (e.g., a privileged user, a user with a user access level of 9/10). In such a case, the user level of that user may indicate that more ports are to be opened than were for the first user so that (i) the IN (e.g., 120A) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IN (e.g., 120A) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, an IN (e.g., 120A) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, an IN (e.g., 120A) of the INs may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

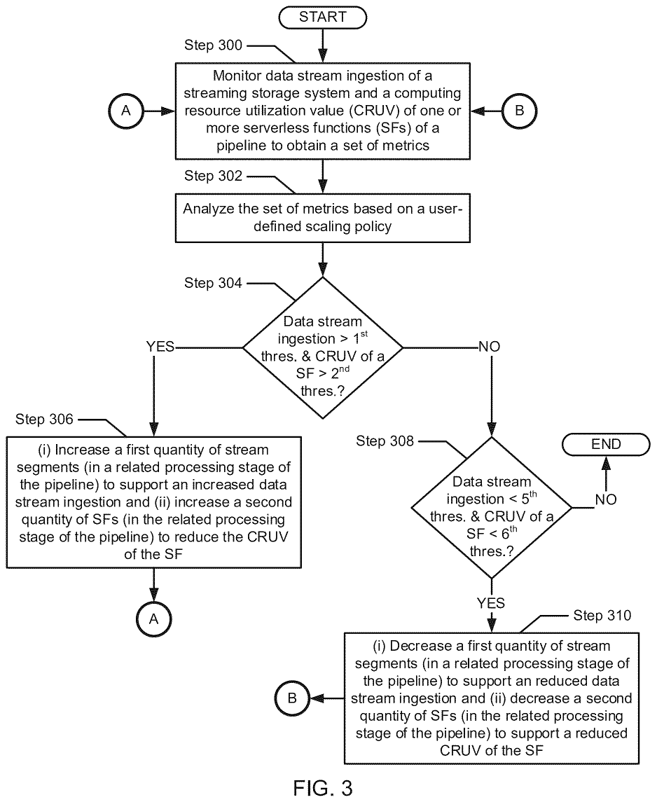

One of ordinary skill will appreciate that an IN (e.g., 120A) of the INs may perform other functionalities without departing from the scope of the embodiments disclosed herein. In one or more embodiments, the IN may be configured to perform (in conjunction with the streaming storage system (125)) all, or a portion, of the functionalities described in FIG. 3.

In one or more embodiments, an IN (e.g., 120A) of the INs may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN may also be implemented as a logical device.

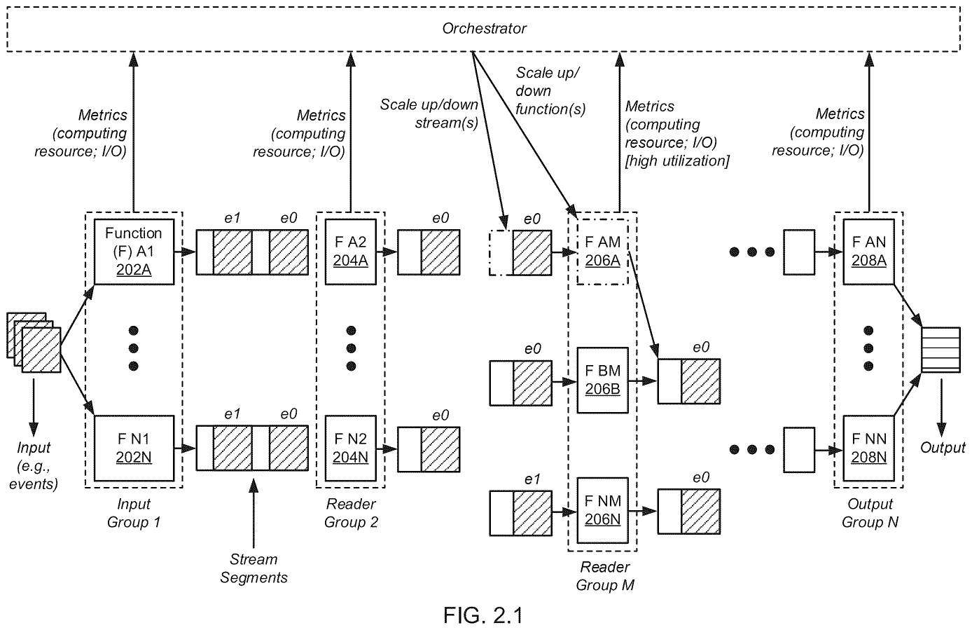

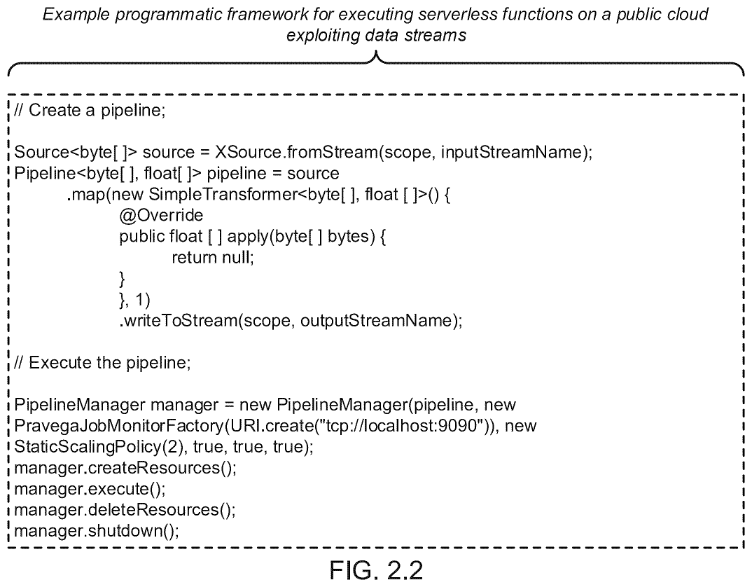

In one or more embodiments, an IN (e.g., 120A) of the INs may host an orchestrator (127). Additional details/functionalities of the orchestrator (127) are described below in reference to FIG. 2.1-3. In the embodiments of the present disclosure, the streaming storage system (125) is demonstrated as a separate entity from the INs; however, embodiments herein are not limited as such. The streaming storage system (125) may be demonstrated as part of an IN (e.g., as deployed to an IN). Additional details of the streaming storage system are described below in reference to FIG. 1.2. Similarly, in the embodiments of the present disclosure, the orchestrator (127) is demonstrated as part of IN A (120A) (e.g., as deployed to IN A (120A)); however, embodiments herein are not limited as such. The orchestrator (127) may be a separate entity from IN A (120A).

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the INs, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the INs through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

While FIG. 1.1 shows a configuration of components, other system configurations may be used without departing from the scope of the embodiments disclosed herein.

Turning now to FIG. 1.2, FIG. 1.2 shows a diagram/architecture of the streaming storage system (125) in accordance with one or more embodiments disclosed herein. The streaming storage system (125) includes a controller (162), a logger (166) (e.g., a bookkeeper service), a segment store (SS) (164), and a consensus service (168) (e.g., a zookeeper service). The streaming storage system (125) may include additional, fewer, and/or different components without departing from the scope of the embodiments disclosed herein. For example, based on the amount of available computing resources in an IN (e.g., 120A, FIG. 1.1), the streaming storage system (125) may host multiple controllers, segment containers (SCs) (e.g., 165A, 165B, etc.), and/or SSs executing contemporaneously, e.g., distributed across multiple servers, VMs, or containers, for scalability and fault tolerance. Each component may be operably connected to any of the other component via any combination of wired and/or wireless connections. Each component illustrated in FIG. 1.2 is discussed below.

The embodiment shown in FIG. 1.2 may show a scenario in which (i) one or more SCs (e.g., 165A, 165B, etc.) are distributed across the SS (164) and (ii) the streaming storage system (125) is an independent system (e.g., meaning that the streaming storage system may customize the resource usage of the SS independently, in an isolated manner).

In one or more embodiments, the streaming storage system (125) allows users (via clients (e.g., Client A (110A))) to ingest data and execute real-time analytics/processing on that data (while guaranteeing data consistency and durability (e.g., once acknowledged, data is never lost)). With the help of the SS (164), the data may be progressively moved to the long-term storage (140) so that users may have access to the data to perform, for example, large-scale batch analytics (e.g., on a cloud (with more resources)), live and historical data playback, etc. Users may define clusters that execute a subset of assigned SCs across the system/framework (e.g., 100, FIG. 1.1) so that different subsets of SCs may be executed on independent clusters (which may be customized in terms of instances and resources per-instance) to adapt different kinds of workloads and hardware components.

In one or more embodiments, the controller (162) may represent a “control plane” and the SS (164) may represent a “data plane”. The SS (164) may execute/host, at least, SC A (165A) and SC (165B) (as “active” SCs, so they may serve write/read operations) (e.g., low-latency durable atomic writes), in which an SC is a unit of parallelism in the streaming storage system (or a unit of work of a SS) and is responsible for executing any storage or metadata operations against the segments (described below) allocated in it. Due to the design characteristics of the streaming storage system (e.g., with the help of the integrated storage tiering mechanism of the streaming storage system), the SS (164) may store data to the long-term storage (140), in which the tiering storage may be useful to provide instant access to recent stream data. Although not shown, the streaming storage system/service (125) may include one or more processors, buses, and/or other components without departing form the scope of the embodiments disclosed herein.

In one or more embodiments, an SC may represent how the streaming storage system (125) partitions a workload (e.g., a logical partition of the workload at the data plane) in order to host segments of streams. Once (automatically) initialized/initiated, an SC may keep executing on its corresponding SS (e.g., a physical component) to perform one or more operations, where, for example, Client A (110A) may not be aware of what the location of an SC in the streaming storage system (125) (e.g., in case Client A wants to generate a new stream with a segment).

In one or more embodiments, depending on the resource capabilities (or resource related parameters) of the streaming storage system (125) (which may be customized over time), the SS (164) (and the SCs hosted by that SS) may provide different functionalities (e.g., providing a better performance). In one or more embodiments, a resource related parameter may include (or specify), for example (but not limited to): a configurable CPU option (e.g., a valid/legitimate virtual CPU count per SS), a configurable network resource option (e.g., allowability of enabling/disabling single-root input/output virtualization (SR-IOV) for specific APIs), a configurable memory option (e.g., maximum and minimum memory per SS), a configurable GPU option (e.g., allowable scheduling policy and/or virtual GPU count combinations), a configurable DPU option (e.g., legitimacy of disabling inter-integrated circuit (I2C) for different SSs), a user type, a network resource related template (e.g., a 10 GB/s BW with 20 ms latency QoS template, a 10 GB/s BW with 10 ms latency QoS template, etc.), a DPU related template (e.g., a 1 GB/s BW vDPU with 1 GB vDPU frame buffer template, a 2 GB/s BW vDPU with 1 GB vDPU frame buffer template, etc.), a GPU related template (e.g., a depth-first vGPU with 1 GB vGPU frame buffer template, a depth-first vGPU with 2 GB vGPU frame buffer template, etc.), a CPU related template (e.g., a 1 vCPU with 4 cores template, a 2 vCPUs with 4 cores template, etc.), a memory related template (e.g., a 4 GB DRAM template, an 8 GB DRAM template, etc.), a vCPU count per SS (e.g., 2, 4, 8, 16, etc.), a speed select technology configuration (e.g., enabled, disabled, etc.), an SS IOMMU configuration (e.g., enabled, disabled, etc.), a wake on LAN support configuration (e.g., supported/enabled, not supported/disabled, etc.), a reserved memory configuration (e.g., as a percentage of configured memory such as 0-100%), a memory ballooning configuration (e.g., enabled, disabled, etc.), a vGPU count per SS (e.g., 1, 2, 4, 8, etc.), a type of a vGPU scheduling policy (e.g., a “fixed share” vGPU scheduling policy, an “equal share” vGPU scheduling policy, etc.), a type of a GPU virtualization approach (e.g., graphics vendor native drivers approach such as a vGPU, hypervisor-enabled drivers approach such as virtual shared graphics acceleration (vSGA), etc.), a user profile folder redirection configuration (e.g., a local user profile, a profile redirection, etc.), a number of SCs available to perform an operation (e.g., 0, 10, 0, etc.), etc.

In one or more embodiments, the control plane may include functionality to, e.g.,: (i) in conjunction with the data plane, generate, alter, and/or delete streams (e.g., index streams (which are useful to enforce retention), byte streams (which are useful to access data randomly at any byte offset), event streams (which are useful to allow parallel writes/reads), etc.); (ii) retrieve information about streams; and/or (iii) monitor health of a streaming storage system cluster (described below) by gathering metrics (e.g., data stream metrics). Further, the SS (164) may provide an API to read/write data in streams.

In one or more embodiments, a “data” stream (described below) may be partitioned/decomposed into stream segments (or simply “segments”). A stream may have one or more segments (where each segment may be stored in a combination of tier-1 storage (e.g., a durable log) and tier-2 storage (e.g., the long-term storage (140))), in which data/event written into the stream may be written into exactly one of the segments based on the event's routing key (e.g., “writer. writeEvent(routingkey, message)”). In one or more embodiments, writers (e.g., of Client A (110A)) may use routing keys (e.g., user identifier, timestamp, machine identifier, etc., to determine a target segment for a stream write operation) so that data is grouped together.

In one or more embodiments, based on the inherent capabilities of the streaming storage system (125), data streams may have multiple open segments in parallel (e.g., enabling the data stream parallelism), both for ingesting and consuming data. The number of parallel stream segments in a stream may automatically grow and shrink over time based on the I/O load (or fluctuations) the stream receives, so that the parallelism of the stream may be modified based on the number of serverless functions to be executed, if needed.

Further, by means of having (i) auto-scaling policies (e.g., user-defined scaling policies) and (ii) a set of metrics for the orchestrator (e.g., 127, FIG. 1.1) and with the help of the data stream parallelism, the orchestrator may enable storage-compute elasticity in data stream processing pipelines, and allow dynamic auto-scaling of serverless functions and stream segments in a coordinated manner.

As described above, a data stream with one or more segments may support parallelism of data writes, in which multiple writers (or multiple writer components) writing data to different segments may exploit/involve one or more servers hosted in a Pravega cluster (e.g., one or more servers, the controller (162), and the SS (164) may collectively be referred to as a “streaming storage system cluster”, in which the cluster may be coordinated to execute the streaming storage system). In one or more embodiments, a consistent hashing scheme may be used to assign incoming events to their associated segments (such that each event is mapped to only one of the segments based on “user-provided” or “event” routing key), in which event routing keys may be hashed to form “key space” and the key space may be divided into a number of partitions, corresponding to the number of segments. Additionally, each segment may be associated with only one instance of SS (e.g., the SS (164)).

In one or more embodiments, from the perspective of a reader component (e.g., Client A (110A) may include a writer component and a reader component), the number of segments may represent the maximum degree of read parallelism possible (e.g., all the events from a set of streams will be read by only one reader in a “reader group (RG)”. If a stream has N segments, then an RG with N reader components may consume from the stream in parallel (e.g., for any RG reading a stream, each segment may be assigned to one reader component in that RG). In one or more embodiments, increasing the number of segments may increase the number of readers in an RG to increase the scale of processing the data from that stream, whereas, as the number of segments decreases, the number of readers may be reduced.

In one or more embodiments, a reader component may read from a stream either at the tail of the stream or at any part of the stream's historical data. Unlike log-based systems that use the same kind of storage for tail reads/writes as well as reads to historical data, a tail of a stream may be kept in tier-1 storage, where write operations may be implemented by the logger (166) as described herein. In some cases (e.g., when a failure has occurred and the system is being recovered), the logger may serve read operations.

In one or more embodiments, the streaming storage system (125) may implement exactly-once semantics (or “exactly once delivery semantics”), which means data is delivered and processed exactly-once (with exact ordering guarantees), despite failures in, for example, Client A (110A), servers, serverless functions (e.g., a mapper function, a reducer function, etc.), stateful operators, and/or the network (e.g., 130, FIG. 1.1). To achieve exactly-once semantics, streams may be durable, ordered, consistent, and/or transactional (e.g., embodiments disclosed herein may enable durable storage of streaming data with strong consistency, ordering guarantees, and high-performance).

As used herein, “ordering” may mean that data is read by reader components in the order it is written. In one or more embodiments, data may be written along with an application-defined routing key, in which the ordering guarantee may be made in terms of routing keys (e.g., a write order may be preserved by a routing key, which may facilitate write parallelism). For example, two pieces of data with the same routing key may be read by a reader in the order they were written. In one or more embodiments, the streaming storage system (more specifically, the SS (164)) may enable an ordering guarantee to allow data reads to be replayed (e.g., when applications fail) and the results of replaying the reads (or the read processes) may be the same.

As used herein, “consistency” may mean that reader components read the same ordered view of data for a given routing key, even in the case of a failure (without missing any data/event). In one or more embodiments, the streaming storage system (more specifically, the SS (164)) may perform idempotent write processes, where rewrites performed as a result of failure recovery may not result in data duplication (e.g., a write process may be performed without suffering from the possibility of data duplication (and storage overhead) on reconnections).

In one or more embodiments, the SS (164) may automatically (e.g., elastically and independently) scale individual data streams to accommodate changes in a data ingestion rate. The SS may enable shrinking of write latency to milliseconds, and may seamlessly handle high-throughput reads/writes from Client A (110A), making the SS ideal for IoT and other time-sensitive implementations. For example, consider a scenario where an IoT application receives information from hundreds of devices feeding thousands of data streams. In this scenario, the IoT application processes those streams to derive a business value from all that raw data (e.g., predicting device failures, optimizing service delivery through those devices, tailoring a user's experience when interacting with those devices, etc.). As indicated, building such an application at scale is difficult without having the components be able to scale automatically as the rate of data increases and decreases.

In one or more embodiments, a data stream may be configured to grow the number of segments as more data is written to the stream, and to shrink when data volume drops off. In one or more embodiments, growing and shrinking a stream may be performed based on a stream's SLO (e.g., to match the behavior of data input). For example, the SS (164) may enable monitoring a rate of data ingest/input to a stream and use the SLO to add or remove segments from the stream. In one or more embodiments, (i) segments may be added by splitting a segment/shard/partition of a stream (e.g., scaling may cause an existing segment, stored at the related data storage thus far, to be split into plural segments; scaling may cause an existing event, stored at the corresponding data storage thus far, to be split into plural events; etc.), (ii) segments may be removed by merging two segments (e.g., scaling may cause multiple existing segments to be merged into a new segment; scaling may cause multiple existing events to be merged into a new event; etc.), and/or (iii) the number of segments may vary over time (e.g., to deal with a potentially large amount of information in a stream). Further, a configuration of a writer component may not change when segments are split or merged, and a reader component may be notified via a stream protocol when segments are split or merged to enable reader parallelism.

Referring to FIG. 1.1, an IN (e.g., 120A, 120N, etc.) may execute one or more stateful or stateless operators/functions (e.g., serverless functions that are connected with one or more data streams) that provides/reports unified and real-time analytics/metrics to the orchestrator (127), while (i) achieving high-throughput and low-latency stream data processing, and (ii) supporting complex event processing and state management. In one or more embodiments, both the IN (e.g., 120A, 120N, etc.) and the streaming storage system (125) may treat a data stream as a first-class primitive, which makes them useful to jointly construct data stream processing pipelines (using serverless functions). In order to enable the streaming storage system (125) to be a data source/sink for the IN (so that, for example, one or more serverless functions may read/write data from/to the SS (164)), each of the serverless functions may execute a connector (e.g., a physical device (i.e., hardware), a logical intelligence (i.e., software), or a combination thereof). For example, a connector of a serverless function may provide a seamless integration with the components of the streaming storage system (125), thereby ensuring parallel data reads/writes, checkpointing, and guaranteeing exactly-once processing with the streaming storage system (125).

As discussed above, one or more readers are organized into a RG and the streaming storage system (125) guarantees that each event written to a data stream is sent exactly one reader with the RG. Further, different RGs may simultaneously read from any given data stream, in which each reader in a RG is assigned to zero or more SSs. This means that a reader that is assigned to a SS is the only reader (within its RG) that reads events from that SS. Readers within a RG may dynamically re-balance the assignment of segments, for example, upon a membership change (e.g., having more or less readers in a RG over time) or when the number of parallel SSs changes because of stream auto-scaling. With the help of a related API (which is provided by its connector), a serverless function may read data streams (from the streaming storage system (125)) to perform one or more streaming jobs.

Further, a connector of a serverless function may ensure a failure recovery for streaming jobs (that are assigned to that serverless function). More specifically, (i) a related IN (e.g., 120A, FIG. 1.1) may implement an asynchronous periodic checkpoint concept (e.g., via the Chandy-Lamport model) to make, for example, serverless function state and stream positions recoverable (for a related serverless function), and (ii) the streaming storage system (125) may implement its own checkpoint concept that applies, for example, a RG that reads from a data stream (where a RG checkpoint generates a consistent reference for a position in the stream that an application (e.g., a serverless function) can roll back to). In one or more embodiments, the connector may have a functionality to combine both checkpoint concepts to recover a stream processing job (e.g., to guarantee failure recovery).

In one or more embodiments, a connector of a serverless function may allow stream processing jobs to write their results to the SS (164) in a consistent, durable, and ordered manner. When used as a sink for stream processing jobs, the connector may also provide exactly-once semantics, in which each incoming event is guaranteed to be effectively processed (e.g., read or written) only once. To be able to provide exactly-once semantics, the connector may implement one or more retries, which means that output of a stream processing job may be partially written. To this end, the streaming storage system (125) (as a data sink) may need to support commits and rollbacks (e.g., to prevent duplicate data reading and to enable recovery in case of a failure), in which the streaming storage system already supports transactional writes (which satisfies the requirement of committing and rolling back).

In one or more embodiments, transactions may (i) allow applications (e.g., serverless functions) to prepare and then commit a set of events that may be written atomically to a data stream and/or (ii) guarantee that either all transaction events are eventually available for reading (or none of the transaction events are available for reading). Further, transactions enable a stream processing job to align a checkpointing process with committing an output, which enables achieving exactly-once processing pipelines (with the coordination (in terms of supporting commits and rollbacks) between the streaming storage system (125) and related INs (e.g., 120A, 120N, etc., FIG. 1.1) via a two-phase commit protocol).

In one or more embodiments, Client A (110A) may send metadata requests to the controller (162) and may send data requests (e.g., write requests, read requests, create a stream, delete the stream, get the segments, etc.) to the SS (164). With respect to a “write path” (which is primarily driven by a sequential write performance of the logger (166)), the writer component of Client A (110A) may first communicate with the controller (162) to perform a write operation (e.g., appending events/data) and to infer which SS it supposed to connect to. Based on that, the writer component may connect to the SS (164) to start appending data. Thereafter, the SS (164) (more specifically, SCs hosted by the SS) may first write data (synchronously) to the logger (166) (e.g., the “tier-1 storage” of the streaming storage system (which typically executes within the cluster), Apache Bookkeeper, a distributed write ahead log, etc.) to achieve data durability (e.g., in the presence of small write operations) and low-latency (e.g., <10 milliseconds) before acknowledging the writer component on every data written (so that data may not be lost as data is saved in protected, persistent/temporary storage before the write operation is acknowledged).

Once acknowledged, in an offline process, the SS (164) may group the data (written to the logger (166) into larger chunks and asynchronously move the larger chunks to the long-term storage (140) (e.g., the “tier-2 storage” of the streaming storage system, pluggable storage, AWS S3, Apache HDFS, Dell Isilon, Dell ECS, object storage, block storage, file system storage, etc.) for high read/write throughput (e.g., to perform batch analytics) (as indicated, Client A (110A) may not directly write to tier-2 storage (e.g., 140)) and for permanent data storage. For example, Client A may send a data request for storing and processing video data from a surgery in real-time (e.g., performing computations (or real-time analytics) on the video data captured by surgery cameras for providing augmented reality capabilities on the video data to help surgeons, where SC A (165A) may be used for this purpose), and eventually, this data may need to be available (or permanently stored) on a larger information technology (IT) facility that hosts enough storage/memory and compute resources (e.g., for executing batch analytics on historical video data to train ML models, where the video data may be asynchronously available in the tier-2 storage).

Further, with respect to a “read path” (which is isolated from the write path), the reader component of Client A (110A) may first communicate with the controller (162) to perform a read operation and to infer which SS it supposed to connect to (e.g., via its memory cache, the SS (164) may indicate where it keeps the data such that the SS may serve tail of data from the cache). For example, if the data is not cached (e.g., historical data), the SS may pull data from the long-term storage (140) so that the reader component performs the read operation (as indicated, the SS may not use the logger (166) to serve a read request of the reader component, where the data in the logger may be used for recovery purposes when necessary).

In one or more embodiments, once data is (and/or will be) provided by Client A (110A) to the SS (164), users may desire access to the data managed by the SS. To facilitate provisioning of access to the data, the SS may manage one or more data structures (in conjunction with the logger (166)), such as block chains, that include information, e.g.,: (i) related to data ownership, (ii) related to the data that is managed, (iii) related to users (e.g., data owners), and/or (iv) related to how users may access the stored data. In one or more embodiments, by providing data management services and/or operational management services (in conjunction with the logger) to the users and/or other entities, the SS may enable any number of entities to access data. As part of providing the data management services, the SS may provide (in conjunction with the logger and/or the long-term storage (140)) a secure method for storing and accessing data. By doing so, access to data in the logger may be provided securely while facilitating provisioning of access to the data.

The data management services and/or operational management services provided by the SS (164) (through, for example, its SCs) may include, e.g.,: (i) obtaining data requests and/or data from Client A (110A) (where, for example, Client A performs a data write operation through a communication channel); (ii) organizing and/or writing/storing the “obtained” data (and metadata regarding the data) to the logger (166) to durably store the data; (iii) generating derived data based on the obtained data (e.g., grouping the data into larger chunks by employing a set of linear, non-linear, and/or ML models), (iv) providing/moving the obtained data, derived data, and/or metadata associated with both data to the long-term storage (140); (v) managing when, how, and/or what data Client A may provide; (vi) temporarily storing the obtained data in its cache for serving that data to reader components; and/or (vii) queueing one or more data requests.

In one or more embodiments, as being part of the tiered storage streaming system (e.g., tier-1 (durable) storage), the logger (166) may provide short-term, low-latency data storage/protection while preserving/guaranteeing the durability and consistency of data written to streams. In one or more embodiments, the logger may exist/execute within the cluster. As discussed above, the SS (164) may enable low-latency, fast, and durable write operations (e.g., data is replicated and persisted to disk before being acknowledged) to return an acknowledgement to a writer component (e.g., of Client A (110A)), and these operations may be optimized (in terms of I/O throughput) with the help of the logger.

In one or more embodiments, to add further efficiency, write operations to the logger (166) may involve data from multiple segments, so the cost of persisting data to disk may be amortized over several write operations. The logger may persist the most recently written stream data (to make sure reading from the tail of a stream can be performed as fast as possible), and as data in the logger ages, the data may be moved to the long-term storage (140) (e.g., a tail of a segment may be stored in tier-1 storage providing low-latency reads/writes, whereas the rest of the segment may be stored in tier-2 storage providing high-throughput read access with near-infinite scale and low-cost). Further, the cluster may use the logger as a coordination mechanism for its components, where the logger may rely on the consensus service (168).

One of ordinary skill will appreciate that the logger (166) may perform other functionalities without departing from the scope of the embodiments disclosed herein. The logger (166) may be implemented using hardware, software, or any combination thereof.

In one or more embodiments, in case of reads, SC A (165A) may have a “read index” that tracks the data read for the related segments, as well what fraction of that data is stored in cache. If a read process (e.g., initiated upon receiving a read request) requests data for a segment that is not cached, the read index may trigger a read process against the long-term storage (140) to retrieve that data, storing it in the cache, in order to serve Client A (110A).

As used herein, data may refer to a “stream data (or a “stream”)” that is a continuous (or continuously generated), unbounded (in size), append-only (e.g., data in a stream cannot be modified but may be truncated, meaning that segments are indivisible units that form the stream), lightweight (e.g., as a file), and durable sequence of bytes (e.g., a continuous data flow/structure that may include data, metadata, and/or the like; a collection of data records called “events”, in which there may not be a limit on how many events can be in a stream or how many total bytes are stored in a stream; etc.) generated (in parallel) by one or more data sources (e.g., 110A, 110N, IoT sensors, etc.). In one or more embodiments, by using append-only log data structures (which are useful for serverless computing frameworks while supporting real-time and historical data access), the SS (164) may enable rapid ingestion of information into durable storage (e.g., the logger (166)) and support a large variety of application use cases (e.g., publish/subscribe messaging, NoSQL databases, event-oriented applications, etc.). Further, a writer component may keep inserting events at one end of a stream and a reader component may keep reading the latest ones from there or for historical reads, the reader component may target specific offsets and keep reading from there.

As used herein, serverless computing frameworks/pipelines may refer to FaaS platforms/pipelines, which allow users to focus only on their code and implementation of the code at a large scale without having to worry about the infrastructure and/or resource management. In most cases, FaaS platforms provide reactive approaches to execute functions (i.e., based events) and to enable stateless computations (e.g., when the execution halts, the “serverless” function may not keep anything in memory unless the function wrote the related data to object storage). Due to their stateless and short-lived nature, serverless functions may need to transfer the results of their computations to other functions via an intermediate system.

While for small computations there may be multiple options (e.g., messaging systems, queues, etc.), for data-intensive FaaS pipelines that manage larger amounts of data (e.g., video files, audio files, images, large text files, etc.), the conventional approach is to store intermediate results as objects in object storage. However, the problem with the conventional approach is that there is a mismatch between the design of the pipeline and the storage layer used by it. The pipeline of data-intensive functions may exploit the fact of using data streams as a substrate for improving latency and processing results byte-by-byte. However, using object storage may force a computation step/stage to be completed and store its results as objects (in object storage) for the next step of functions to be triggered. This may induce additional latency that impact on the overall performance of the pipeline. In the case of a failure, using the object storage (as a storage layer for intermediate function results) may provide no mechanism for guaranteeing exactly-once semantics in the pipeline. That this, if there is a failure in the execution of the pipeline, data may be processed twice or some data may be missed to generate the result, and one or more embodiments disclosed herein advantageously overcome these issues.

Continuing with the discussion of FIG. 1.2, an event may be a collection of bytes within a stream (or a contiguous set of related extents of unbounded, continuously generated data) (e.g., a small number of bytes including a temperature reading from an IoT sensor composed of a timestamp, a metric identifier, and a value; web data associated with a user click on a website; a timestamped readout from one sensor of a sensor array; etc.). Said another way, events (which are atomic) may be appended to segments of a data stream (e.g., a stream of bytes), where segments are the unit of storage of the data stream (e.g., a data stream may be comprised of one or more segments, where (i) each segment may include one or more events (where a segment may not store events directly, the segment may store the append-only sequence of bytes of the events) and (ii) events may be appended to segments by serializing them into bytes, where once written, that sequence of bytes is immutable). In one or more embodiments, events may be stored along a data stream in parallel to one another and/or in succession to one another (where segments may provide parallelism). That is, one or more events may have data occurring in parallel, or having occurred in parallel. Further, one or more events may sequentially follow one or more other events, such as having data that occurs after one or more other events, or has occurred after data from one or more other events.

In one or more embodiments, the number of segments for appending and/or truncating (e.g., the oldest data from a stream without compromising with the data format) may vary over a respective unit axis of a data stream. It will be appreciated that a data stream may be represented relative to a time axis. That is, data and/or events may be written to and/or appended to a stream continuously, such as in a sequence or in an order. Likewise, such data may be reviewed and/or analyzed by a user in a sequence or in an order (e.g., a data stream may be arranged based upon a predecessor-successor order along the data stream).

Sources of data written, posted, and/or otherwise appended to a stream may include, for example (but not limited to): online shopping applications, social network applications (e.g., producing a stream of user events such as status updates, online transactions, etc.), IoT sensors, video surveillance cameras, drone images, autonomous vehicles, servers (e.g., producing a stream of telemetry information such as CPU utilization, memory utilization, etc.) etc. The data from streams (and thus from the various events appended to the streams) may be consumed, by ingesting, reading, analyzing, and/or otherwise employing in various ways (e.g., by reacting to recent events to analyze historical stream data).

In one or more embodiments, an event may have a routing key, which may be a string that allows the streaming storage system (125) and/or administrators to determine which events are related (and/or which events may be grouped) (e.g., when working with data streams having parallel segments, applications requiring total order of events are expected to use routing keys for writing data). A routing key may be derived from data, or it may be an artificial string (e.g., a universally unique identifier) or a monotonically increasing number. For example, a routing key may be a timestamp (to group events together by time), or an IoT sensor identifier (to group events by a machine). In one or more embodiments, a routing key may be useful to define precise read/write semantics. For example, (i) events with the same routing key may be consumed in the order they were written and (ii) events with different routing keys sent to a specific reader will always be processed in the same order even if that reader backs up and re-reads them.

As discussed above, the streaming storage system (125) (e.g., an open-source, distributed and tiered streaming storage system providing a cloud-native streaming infrastructure (i) that is formed by controller instances and SS instances, (ii) that eventually stores stream data in a long-term storage (e.g., 140), (iii) that enables auto-scaling of streams (where a degree of parallelism may change dynamically in order to react workload changes) and its connection with serverless computing, and (iv) that supports both a byte stream (allowing data to be access randomly by any byte offset) and an event stream (allowing parallel writes/reads)) may store and manage/serve data streams, in which the “stream” abstraction in the streaming storage system is a first-class primitive for storing continuous and unbounded data. A data stream in the streaming storage system guarantees strong consistency and achieves good performance (with respect to data storage and management), and may be combined with one or more stream processing engines (e.g., Apache Flink) to initiate streaming applications.

In one or more embodiments, Client A (110A) may concurrently have dynamic write/read access to a stream where other clients (using the streaming storage system (125)) may be aware of all changes being made to the stream. The SS (164) may track data that has been written to the stream. Client A may update the stream by sending a request to the SS that includes the update and a total length of the stream that was written at the time of a last read update by Client A. If the total length of the stream received from Client A matches the actual length of the stream maintained by the SS, the SS may update the stream. If not, a failure message may be sent to Client A and Client A may process more reads to the stream before making another attempt to update the stream.

In one or more embodiments, Client A (110A) may provide a client library that may implement an API for the writer and reader components to use (where an application may use the API to read and write data from and to the storage system). The client library may encapsulate a protocol used for a communication between Client A and the streaming storage system (e.g., the controller (162), the SS (164), etc.). As discussed above, (i) a writer component may be an application that generates events/data and writes them into a stream, in which events may be written by appending to the tail (e.g., front) of the stream; (ii) a reader component may be an application that reads events from a stream, in which the reader component may read from any point in the stream (e.g., a reader component may be reading events from a tail of a stream); and (iii) events may be delivered to a reader component as quickly as possible (e.g., events may be delivered to a reader component within tens of milliseconds after they were written).

In one or more embodiments, segments may be illustrated as “Sn” with n being, for example, one through ten. A low number n indicates a segment location closer to a stream head and a high number n indicates a segment location closer to a stream tail. In general, a stream head refers to the smallest offsets of events that have no predecessor (e.g., the beginning of a stream, the oldest data, etc.). Such events may have no predecessor because either such events are the first events written to a stream or their predecessors have been truncated. Likewise, a stream tail refers to the highest offsets of events of an open stream that has no successor (e.g., the most recently written events and/or last events, the end of a stream where new events are appended, etc.). In one or more embodiments, a segment may be (i) an “open segment” indicating that a writer component may write data to that segment and a reader component may consume that data at a later point-in-time, and (ii) a “sealed/immutable segment” indicating that the segment is read-only (e.g., which may not be appended).

In one or more embodiments, a reader component may read from earlier parts (or at an arbitrary position) of a stream (referred to as “catch-up reads”, where catch-up read data may be cached on demand) and a “position object (or simply a “position”)” may represent a point in the stream that the reader component is currently located.

As used herein, a “position” may be used as a recovery mechanism, in which an application (of Client A (110A)) that persist the last position of a “failed” reader component that has successfully processed may use that position to initialize a replacement reader to pick up where the failed reader left off. In this manner, the application may provide exactly-once semantics (e.g., exactly-once event processing) in the case of a reader component failure.

In one or more embodiments, multiple reader components may be organized into one or more RGs, in which an RG may be a named collection of readers that together (e.g., in parallel, simultaneously, etc.) read events from a given stream. Each event published into a stream may be guaranteed to be sent to one reader component within an RG. In one or more embodiments, an RG may be a “composite RG” or a “distributed RG”, where the distributed RG may allow a distributed application to read and process data in parallel, such that a massive amount of data may be consumed by a coordinated fleet of reader components in that RG. A reader (or a reader component) in an RG may be assigned zero or more stream segments from which to read (e.g., a segment is assigned to one reader in the RG, which gives the “one segment to one reader” exclusive access), in which the number of stream segments may be balanced to which the reader is assigned. For example, the reader may read from two stream segments while another reader in the RG may only read one stream segment.

In one or more embodiments, reader components may be added to an RG, or reader components fail and may be removed from the RG, and a number of segments in a stream may determine the upper bound of “read” parallelism of readers/reader components within the RG. Further, an application (of Client A (110A)) may be made aware of changes in segments (via the SS (164)). For example, the application may react to changes in the number of segments in a stream (e.g., by adjusting the number of readers in an associated RG) to maintain maximum read parallelism if resources allow.

In one or more embodiments, events may be appended to a stream individually, or may be appended as a stream transaction (no size limit), which is supported by the streaming storage system (125). As used herein, a “transaction” refers to a group/set of multiple events (e.g., a writer component may batch up a bunch of events in the form of a transaction and commit them as a unit into a stream). For example, when the controller (162) invokes committing a transaction (e.g., as a unit into a stream), the group of events included in the transaction may be written (via the writer component) to a stream as a whole (where the transaction may span multiple segments of the stream) or may be abandoned/discarded as a whole (e.g., if the writer component fails). With the use of transactions, a writer component may persist data at a point-in-time, and later decide whether the data should be appended to a stream or abandoned. In one or more embodiments, a transaction may be implemented similar to a stream, in which the transaction may be associated with multiple segments and when an event is published into the transaction, (i) the event itself is appended to a segment of the transaction (where data written to the transaction is just as durable as data written directly to a stream) and (ii) the event may not be visible to a reader component until that transaction is committed. Further, an application may continuously produce results of a data processing operation and use the transaction to durably accumulate the results of the operation.

In one or more embodiments, as being a stateless component, the controller (162) may (further) include functionality to, e.g.,: (i) manage the lifecycle of a stream and/or transactions, in which the lifecycle of the stream includes features such as generation, scaling, modification, truncation, and/or deletion of a stream (in conjunction with the SS (164)); (ii) manage a retention policy for a stream that specifies how the lifecycle features are implemented (e.g., requiring periodic truncation); (iii) manage transactions (e.g., generating transactions (e.g., generating transaction segments), committing transactions (e.g., merging transaction segments), aborting transactions (e.g., dropping a transaction segment), etc.); (iv) be dependent on stateful components (e.g., the consensus service (168), the logger (166) (for the write ahead log functionalities)); (v) manage (and authenticate) metadata requests (e.g., get information about a segment, get information about a stream, etc.) received from Client A (110A) (e.g., manage stream metadata); (vi) be responsible for distribution/assignment of SCs into one or more SSs executing on the streaming storage system (125) (e.g., if a new SS (or a new SS instance) is added to the streaming storage system, the controller may perform a reassignment of SCs along all existing SSs to balance/split the workload); (vii) be responsible for making sense of segments; (viii) manage/enforce an auto-scaling policy for a stream that allows the streaming storage system to automatically change the segment parallelism of a data stream based on an ingestion workload (e.g., events/bytes per second); and/or (ix) manage a control plane of the streaming storage system (125).

In one or more embodiments, although data streams are typically unbounded, truncating them may be desirable in practical real-world scenarios to manage the amount of storage space the data of a stream utilizes relative to a stream storage system. This may particularly be the case where storage capacity is limited. Another reason for truncating data streams may be regulatory compliance, which may dictate an amount of time an application retains data.

In one or more embodiments, a stream may dynamically change over time and, thus, metadata of that stream may change over time as well. Metadata of a stream may include (or specify), for example (but not limited to): configuration information of a segment, history of a segment (which may grow over time), one or more scopes, transaction metadata, a logical structure of segments that form a stream, etc. The controller (162) may store metadata of streams (which may enable exactly-once semantics) in a table segment, which may include an index (e.g., a B+ tree index) built on segment attributes (e.g., key-value pairs associated to segments). In one or more embodiments, the corresponding “stream metadata” may further include, for example, a size of a data chunk stored in long-term storage (140) and an order of data in that data chunk (for reading purposes and/or for batch analytics purposes at a later point-in-time).

As used herein, a “scope” may be a string and may convey information to a user/administrator for the corresponding stream (e.g., “FactoryMachines”). A scope may act as a namespace for stream identifiers (e.g., as folders do for files) and stream identifiers may be unique within a scope. Further, a stream may be uniquely identified by a combination of its stream identifier and scope. In one or more embodiments, a scope may be used to separate identifiers by tenants (in a multi-tenant environment), by a department of an organization, by a geographic location, and/or any other categorization a user selects.

One of ordinary skill will appreciate that the controller (162) may perform other functionalities without departing from the scope of the embodiments disclosed herein. The controller (162) may be implemented using hardware, software, or any combination thereof.

In one or more embodiments, as being a stateless component, the SS (164) may (further) include functionality to, e.g.,: (i) manage the lifecycle of segments (where the SS may be unaware of streams but may store segment data); (ii) generate, merge, truncate, and/or delete segments, and serve read/write requests received from Client A (110A); (iii) use both a durable log (e.g., 166) and long-term storage (140) to store data and/or metadata; (iv) append new data to the durable log synchronously before responding to Client A, and write data asynchronously to the long-term storage (which is the primary destination of data); (v) use its cache to serve tail stream reads, to read ahead from the long-term storage, and/or to avoid reading from the durable log when writing to the long-term storage; (vi) monitor the rate of event traffic in each segment individually to identify trends and based on these trends, associate a trend label (described below) with the corresponding segment; (vii) make sure that each segment maps to only one SC (via a hash function) at any given time, in which that SS instance may maintain metadata (e.g., a rate of traffic into the related segment locally, a scaling type, a target rate, etc.); (viii) in response to a segment being identified as being either hot or cold, the hot/cold segment state is communicated to a central scaling coordinator component of the controller (162) (in which that component consolidates the individual hot/cold states of multiple segments and calculates a centralized auto-scaling decision for a stream such as by replacing hot segments with multiple new segments and/or replacing multiple cold segments with a consolidated newer segment); (ix) be dependent on stateful components (e.g., the consensus service (168), the logger (166) (for the write ahead log functionalities)); (x) manage data paths (e.g., a write path, a read path, etc.); (xi) manage (and authenticate) data requests received from Client A; and/or (xii) manage a data plane of the streaming storage (125) (e.g., implement read, write, and other data plane operations).

One of ordinary skill will appreciate that the SS (164) may perform other functionalities without departing from the scope of the embodiments disclosed herein. The SS (164) may be implemented using hardware, software, or any combination thereof.

In one or more embodiments, a trend label may have one of three values, e.g., “normal”, “hot”, or “cold”. A segment identified as “hot” may be characterized by a traffic trend that is greater than a predetermined target rate of traffic. The target rate may be supplied by a user via predetermined a stream policy (e.g., a stream/scaling policy may be defined on a data stream such that if a segment gets more than the required number of events, it may be divided). A segment identified as “cold” may be characterized by a traffic trend that is less than the target traffic rate. For example, a hot segment may be a candidate for scale-up into two or more new segments (e.g., Segment 2 being split into Segment 4 and Segment 5). As yet another example, a cold segment may be a candidate for scale-down via merger with one or more other cold segments (e.g., Segment 4 and Segment 5 being merged into Segment 6). As yet another example, a normal segment may be a candidate for remaining as a single segment.

In one or more embodiments, a consensus service may be required to have/keep a consistent view/state of a current SC distribution/assignment across the streaming storage systems (executing on the system (e.g., 100, FIG. 1.1)). For example, identifiers of SCs and their assignments may need to be consistent across the streaming storage systems and one way to achieve this is implementing the consensus service. To this end, the consensus service (168) (e.g., Apache Zookeeper) may include functionality to, e.g.,: (i) perform one or more coordination tasks (e.g., helping to the controller (162) for the assignment/distribution of SCs to SS instances, helping a split of workloads across segments, etc.), and/or (ii) store no stream metadata.

One of ordinary skill will appreciate that the consensus service (168) may perform other functionalities without departing from the scope of the embodiments disclosed herein. The consensus service (168) may be implemented using hardware, software, or any combination thereof.

In one or more embodiments, SC A (165A) and SC B (165B) may allow users and/or applications to read/access data that was written in SC A and SC B and stored in the long-term storage (140) at the background. In one or more embodiments, SC A and SC B may be useful to perform an active-passive data replication. For example, SC A and SC B are writing data and at the same time, SS A and SS B may serve batch analytics tasks (e.g., batch reads) of data processing applications (of Client A (110A)) (for example, for a better user experience).

Further, the embodiment provided in FIG. 1.2 may utilize the inherent capabilities of the streaming storage system (125) to move data to the long-term storage (140) jointly with the SCs (e.g., 165A, 165B, etc.) as a form of active-passive data replication, which is useful for various different analytics workloads. For example, a user (of Client A (110A)) may perform real-time analytics on stream data (with the help of the logger (166), where the logger may persist the most recently written stream data) and at the same time, the related SCs (e.g., SC A, SC B, etc.) may move the data progressively to the long-term storage (140) (i) for serving batch reads/analytics at a later point-in-time (for example, upon receiving a batch read request from the user) and (ii) for enabling storage tiering capabilities provided by the streaming storage system (e.g., to perform active-passive data replication).

In one or more embodiments, as being part of the tiered storage streaming system (e.g., tier-2 storage), the long-term storage (140) may provide long-term (e.g., near-infinite retention), durable, high read/write throughput (e.g., to perform batch analytics; to perform generate, read, write, and delete operations; erasure coding; etc.) historical stream data storage/protection with near-infinite scale and low-cost. The long-term storage may be, for example (but not limited to): pluggable storage, AWS S3, Apache HDFS, Dell Isilon, Dell ECS, object storage, block storage, file system storage, etc. Referring to FIG. 1.2, the long-term storage (140) may be located/deployed outside of the streaming storage system (125), in which asynchronous migration of events from tier-1 storage to tier-2 storage (without affecting the performance of tail reads/writes) may reflect different access patterns to stream data.

In one or more embodiments, the long-term storage (140) may be a fully managed cloud (or local) storage that acts as a shared storage/memory resource that is functional to store unstructured and/or structured data. Further, the long-term storage (140) may also occupy a portion of a physical storage/memory device or, alternatively, may span across multiple physical storage/memory devices.

In one or more embodiments, the long-term storage (140) may be implemented using physical devices that provide data storage services (e.g., storing data and providing copies of previously stored data). The devices that provide data storage services may include hardware devices and/or logical devices. For example, the long-term storage may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the long-term storage (140) may include a memory device (e.g., a dual in-line memory device), in which data is stored and from which copies of previously stored data are provided. As yet another example, the long-term storage may include a persistent storage device (e.g., an SSD), in which data is stored and from which copies of previously stored data is provided. As yet another example, the long-term storage may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the long-term storage (140) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the long-term storage (140) may store/log/record unstructured and/or structured data that may include (or specify), for example (but not limited to): a valid (e.g., a granted) request and its corresponding details, an invalid (e.g., a rejected) request and its corresponding details, historical stream data and its corresponding details, content of received/intercepted data packets/chunks, information regarding a sender (e.g., a malicious user, a high priority trusted user, a low priority trusted user, etc.) of data, information regarding the size of intercepted data packets, a mapping table that shows the mappings between an incoming request/call/network traffic and an outgoing request/call/network traffic, a cumulative history of user activity records obtained over a prolonged period of time, a cumulative history of network traffic logs obtained over a prolonged period of time, previously received malicious data access requests from an invalid user, a backup history documentation of a workload, a model name of a hardware component, a version of an application, a product identifier of an application, an index of an asset (e.g., a file, a folder, a segment, etc.), recently obtained customer/user information (e.g., records, credentials, etc.) of a user, a cumulative history of initiated model training operations (e.g., sessions) over a prolonged period of time, a restore history documentation of a workload, a documentation that indicates a set of jobs (e.g., a data backup job, a data restore job, etc.) that has been initiated, a documentation that indicates a status of a job (e.g., how many jobs are still active, how many jobs are completed, etc.), a cumulative history of initiated data backup operations over a prolonged period of time, a cumulative history of initiated data restore operations over a prolonged period of time, an identifier of a vendor, a profile of an invalid user, a fraud report for an invalid user, one or more outputs of the processes performed by the controller (162), power consumption of components of the streaming storage system (125), etc. Based on the aforementioned data, for example, the orchestrator (e.g., 127, FIG. 1.1) may perform user analytics to infer profiles of users communicating with components exist in the streaming storage system.

In one or more embodiments, the unstructured and/or structured data may be updated (automatically) by third-party systems (e.g., platforms, marketplaces, etc.) (provided by vendors) or by administrators based on, for example, newer (e.g., updated) versions of SLAs being available. The unstructured and/or structured data may also be updated when, for example (but not limited to): a data backup operation is initiated, a set of jobs is received, a data restore operation is initiated, an ongoing data backup operation is fully completed, etc.

In one or more embodiments, the unstructured and/or structured data may be maintained by, for example, IN A (e.g., 120A, FIG. 1.1). IN A may add, remove, and/or modify those data in the long-term storage (140) to cause the information included in the long-term storage to reflect the latest version of, for example, SLAs. The unstructured and/or structured data available in the long-term storage may be implemented using, for example, lists, tables, unstructured data, structured data, etc. While described as being stored locally, the unstructured and/or structured data may be stored remotely, and may be distributed across any number of devices without departing from the scope of the embodiments disclosed herein.

While the long-term storage (140) has been illustrated and described as including a limited number and type of data, the long-term storage may store additional, less, and/or different data without departing from the scope of the embodiments disclosed herein. In the embodiments described above, the long-term storage is demonstrated as a separate entity; however, embodiments herein are not limited as such. In one or more embodiments, the long-term storage (140) may be a part of a cloud.

One of ordinary skill will appreciate that the long-term storage (140) may perform other functionalities without departing from the scope of the embodiments disclosed herein. The long-term storage may be implemented using hardware, software, or any combination thereof.

Turning now to FIG. 2.1, FIG. 2.1 shows a scenario about how an orchestrator (e.g., a FaaS auto-scaler coordinator) manages/performs/initiates coordinated and dynamic auto-scaling of data-intensive serverless functions and elastic streams (e.g., data streams and their segments) in serverless function pipelines in accordance with one or more embodiments disclosed herein. The scenario, illustrated in FIG. 2.1 and described below, is explanatory purposes only and not intended to limit the scope disclosed herein. The orchestrator may be an example of the orchestrator discussed above in reference to FIG. 1.1.

In one or more embodiments, the orchestrator may utilize “stream transaction (described above in reference to FIG. 1.2)” and “checkpoint” functionalities of the streaming storage system (e.g., 125, FIG. 1.2) to achieve/provide exactly-once semantics in data-intensive serverless function pipelines (e.g., to guarantee that events in pipelines are ingested exactly once).

As used herein, a “checkpoint” may generate a consistent “point-in-time” persistence of each reader in a reader group (e.g., Reader Group M) using a specialized event (e.g., a checkpoint event) to signal each reader to preserve its state. Stream users (e.g., user entities, readers, reader components, etc.) may generate (via a state synchronizer) one or more checkpoints relative to a data stream. A checkpoint may be a named set of offsets for one or more stream events that an application (e.g., a reader, a serverless function, etc.) may use to resume from. One or more checkpoints may be employed by an application to mark a position in a data stream at which to roll back to at a future reading session, in which in the case of stateful applications, such “stream” checkpoints may be coordinated with checkpoints of the application itself.

In one or more embodiments, a checkpoint may be built upon, and thus, may include one or more stream cuts (or manage those stream cuts in a coordinated way), in which (i) a stream cut may mark a position in a data stream (e.g., in a segment) specifying that where each reader (e.g., each serverless function) is and (ii) in a checkpoint, the stream cut may provide the position information for the data stream. Those skilled in the art will appreciate that a stream cut may be provided separately from a checkpoint as well. In one or more embodiments, one or more stream cuts (e.g., a collection of segments and the corresponding offsets in the segments that may be picked up to resume a process) may be stored in a key-value table (not shown), in which storing may include, for example, uploading, downloading, posting, writing, generating, and/or the like.

In the key-value table (e.g., an API of the streaming storage system (e.g., 125, FIG. 1.2)), stream cuts and checkpoints (e.g., checkpoint 0 and its associated data, checkpoint 1 and its associated data, etc.) may be stored based on any suitable ordering, such as being ordered according to time, and may include an identifier that corresponds to (i) a location along a data stream or (ii) a location of multiple segments of a data stream that are written in parallel along a data stream.

In one or more embodiments, a state synchronizer (which is an API provided by the streaming storage system (e.g., 125, FIG. 1.2)) may initiate a checkpoint on a reader group, in which once the checkpoint has been completed, the state synchronizer may use the checkpoint to reset all the readers in the reader group to the known consistent state represented by the checkpoint. In one or more embodiments, a state synchronizer may, e.g.,: (i) be a basis to linearize and make consistent changes on a shared state across different functions with an optimistic concurrency (e.g., the state synchronizer may enable reads and changes (by the corresponding readers/functions) to be made to the shared state with consistency); (ii) provide strong consensus for a reader group with respect to replicated state machines (e.g., enabling applications to replicate states), leader election, membership management, transaction management, and/or other distributed computing functionalities; (iii) use a data stream to provide a synchronization mechanism for a state shared between multiple processes running in a cluster; (iv) be used to store data or a map with different key-value pairs in the key-value table; (v) be used to manage a state of a reader group and the corresponding readers; (vi) be a component where changes to a shared state may be written through it to a data stream to keep track of all changes to the shared state; and/or (vii) help readers such that the readers may track the states of distributed events (e.g., which segments are assigned to which readers, pending checkpoints, positions of each reader in a reader group at the time of a checkpoint, etc.), for example, for consistent workload balancing.

In one or more embodiments, no two concurrent transactions may be allowed to proceed. This may be required to prevent any duplicates because when a reader performs its job, the reader may need to update a state of the synchronizer conditionally before reading and committing/processing.

Referring to FIG. 2.1, the streaming storage system (e.g., 125, FIG. 1.2) may be utilized as a storage substrate (e.g., may be utilized as an intermediate result storage and transfer layer) for data-intensive serverless functions (e.g., mapper functions, reducer functions, etc.) and for data-intensive serverless function (FaaS) pipelining (e.g., Function A1 (202A) may use a data stream to transfer its intermediate results instead of storing those results in object storage (as inputs for another function (e.g., Function A2 (204A)) to retrieve/read)). Further, an input dataset (or input) (e.g., events, data, etc.) and an output dataset (or output of a stream processing job) of the whole pipeline may still be stored in object storage (e.g., the long-term storage), in which all the partial/intermediate results from the calculations (performed by the serverless functions) are written to one or more stream segments of related data streams, in order to, at least, optimize all the intermediate data transfers across the functions.

Referring to FIG. 2.1, the orchestrator may employ a processing model to organize FaaS functions (e.g., serverless functions) into one or more processing stages/groups, in which each stage may be composed by one or more serverless functions in a reader group consuming data/event from a data stream (or the data stream's segments). The output of serverless functions belonging to a particular processing stage may then be written to another data stream, which can serve as input for the next processing stage.

More specifically, each group/stage of data-intensive serverless functions consuming/reading from a data stream is organized as a separate reader group (and connected by data streams), in which instead of writing on a per-event basis, data in the data stream can be written as transactions (as a group of multiple events (e.g., e0, e1, etc.)). For example, (i) “Input Group 1” may include, at least, Function A1 (202A) and Function N1 (202N) (in which the group receives a data stream that includes multiple stream segments as inputs (e.g., Function N1 may receive a video file, resize the video file, and write the resized video file to the data stream)); (ii) “Reader Group 2” may include, at least, Function A2 (204A) and Function N2 (204N) (in which each function/reader reads from the corresponding stream segment (e.g., Function N2 may blur off faces in the resized video file and write its intermediate results to another data stream)); (iii) “Reader Group M” may include, at least, Function BM (206B) and Function NM (206N) (in which each function reads from the corresponding segment (e.g., Function NM may generate a thumbnail based on the intermediate results of Function N2)); and (iv) “Output Group N” may include, at least, Function AN (208A) and Function NN (208N) (in which the group generates a data output and then store the data output to the long-term storage (e.g., 140, FIG. 1.2), for example, for later use).

For example, as being a second group of functions, as soon as an intermediate result(s) are written (by Function A1 and Function N1) to a related data stream (e.g., (a) without waiting for Function A1 and Function N1 to complete their whole computations/processes on the data input and (b) allowing the function pipelining in a stream manner/fashion as soon as the first byte of information is available (in the data stream) to process), Function A2 Function N2 may start processing/reading the corresponding intermediate results from the data stream.

In one or more embodiments, for each reader group, one or more checkpoints may be configured to be triggered periodically (e.g., every 10 seconds) or in demand and in the meantime, serverless functions (e.g., 204A, 204N, 206N, etc.) may consume data from the appropriate data stream and write their intermediate/partial results on the corresponding stream (or stream transaction). Accordingly, one or more stream cuts may indicate (i) which function is reading from what location in the stream and/or (ii) the locations at where all these functions were reading at a point of a checkpoint.

In one or more embodiments, for example, each function in “Reader Group 2” may coordinate with the state synchronizer to initiate a checkpoint. Based on that, each function may update/store its local state and then each function may flush/write any event that needs to flushed (e.g., when a checkpoint generation is triggered, functions within a reader group may flush any remaining event to the corresponding transaction and after the checkpoint is generated, functions may commit their respective transactions). Once this process is completed, each function may notify/update the state synchronizer indicating that each function completed the flushing. Thereafter, the state synchronizer may collectively generate a stream cut (or multiple stream cuts), for example, that represent a function's position at the time the state synchronizer received a “completion” notification from the function. Based on that, if necessary (e.g., in the case of a function failure/crash in between checkpoints), the function may be re-initiate/re-triggered (by the orchestrator) and may roll back to the stream cut point and resumes its job/operation (rather than processing form the beginning).

From a different perspective, for example, (i) at a first point-in-time, any remaining events may be flushed to the corresponding transaction, (ii) at a second point-in-time, a checkpoint may be generated, (iii) at a third point-in-time, the corresponding transactions may be committed, (iv) after (i)-(iii) are completed successfully, a stream cut may be generated and stored (along with the associated checkpoint data) in the key-value table (to indicate that until this stream cut, everything was normal), and/or (v) after (i)-(iv) are completed successfully, a newer process/cycle may be started. If a function crashes in the middle of the aforementioned cycle (e.g., because the function have not committed the corresponding group of events (or transactions)), the function may roll back to the most recent stream cut point and resumes from there.

In one or more embodiments, checkpoint data may include (or specify), for example (but not limited to): a last known offset in a data stream (e.g., to resume processing), a transaction identifier of a transaction, an identifier of a stream segment assigned to a serverless function, etc.

In one or more embodiments, stream transactions (in the streaming storage system (e.g., 125, FIG. 1.2)) guarantee that all the events in a transaction are visible to the corresponding readers atomically. For example, (i) eventually, the transaction is aborted due a failure of a function, so none of “event 0, event 1, and event 2” of the transaction are visible to any readers, or (ii) eventually, the transaction is committed successfully, so the readers will be able to read all the events. To this end, the data from the checkpoint and the transaction identifier (TID) (which is managed by the controller (e.g., 162, FIG. 1.2)) per-reader should be persistently stored (in the key-value table) in order to track (in each processing stage of the serverless function pipeline) the last committed group of messages/events and the position of readers when this happened.

In the case of a failure (e.g., if a serverless function crashes in the middle of a transaction, if the function committed to a first transaction but have not committed to a second transaction and then the function fails, etc.), the function (after re-initiated) may retrieve the corresponding information from the key-value table to infer (i) where is the correct position in the stream to resume processing, (ii) the last transaction that was committed by the function before the failure, and/or (iii) up to what offset has been successfully committed (with the help of the function's states (where a “state” may represent a starting file offset and a TID), where the function keeps its states using the state synchronizer).

In the positive case (e.g., if the function fails/crashes after completing the corresponding transaction), a newer serverless function (or the re-initiated function) may just need to re-take the segments assigned to the function (related to the failure) and continue processing the transaction (with the help of the state synchronizer). In the negative case (e.g., if the function fails/crashes before completing the corresponding transaction), the corresponding transaction may still be open (e.g., events may have been appended but the transaction is still open). For this reason, a new function (or the re-initiated function) may need to own the transaction again and complete the commit process before resuming its processing (e.g., the new function may read the latest state from the state synchronizer to infer the status of the “failed”transaction based on the corresponding TID to start over).

In one or more embodiments, in both cases, it may be possible to continue processing right from a stream location at which the “previous” function crashed, in which checkpoint information/data may be useful to recover from this crash impacting all the other functions within the related reader group. If only a single function crashes, logic of the related reader group may re-assign the segments associated with the crashed function to other functions of the related reader group, which may then resume processing from the last known position for that function (e.g., the last checkpoint).

Referring to FIG. 2.1, both the input stage (e.g., Input Group 1) and the output stage (e.g., Output Group N) may differ from the intermediate stages (e.g., Reader Group 2 and Reader Group M). For example, Input Group 1 (the input serverless functions group) may keep track (via the key-value table of the streaming storage system) of the progress of the input (or the input dataset), which may occur outside of the streaming storage system (e.g., the object being read/or its offset). As yet another example, Output Group N (the output serverless functions group) may keep track of the progress of the output (or the output dataset) in the case of a crash. Both stages may be necessary to be able to satisfy exactly-once semantics (in an end-to-end manner), which involves interactions with external input/output services.

As discussed above, serverless functions and grouping/staging of these functions may be managed/coordinated by the orchestrator (e.g., a FaaS scheduler of a FaaS platform that utilizes functionalities provided by the streaming storage system (e.g., 125, FIG. 1.1)), which is a separate entity from the streaming storage system. The orchestrator may also initiate repartitioning of a given data stream according to the number of serverless functions writing and reading data to/from the data stream, which may help aligning the parallelism of the stream data with the number of serverless functions (e.g., the compute parallelism) towards providing overall performance improvements in data-intensive FaaS pipelines (where serverless functions execute almost in parallel, which significantly increases compute parallelism and reduce execution time(s) associated with each function). The orchestrator may be implemented using hardware, software, or any combination thereof.

Further, the implementation of the streaming storage system (e.g., 125, FIG. 1.2) for pipelining data-intensive serverless functions improves the overall performance of the functions (because there is no need to wait for the previous function to complete and store its result to object storage) so that the functions may feed on results of other functions as soon as the first byte (of a result) is available, rather than waiting for a function to complete its job to ingest its output. Referring to FIG. 2.1, using data streams, instead of objects to store intermediate results, in FaaS pipelines may significantly increase compute parallelism and reduce execution time(s) (e.g., associated with each function).

As indicated above, it is key to set the correct number of stream segments according to the number of parallel serverless functions in use (e.g., correct-sizing of the stream parallelism). This is not only important for the ingestion throughput of a data stream(s), but also important to enable/facilitate the interaction of serverless functions with the streaming storage system (e.g., reading from a stream, writing to the stream, etc.). That is, the number of stream segments lower than the number of readers/functions would mean that there would be serverless functions unable to read data, and therefore, not able to perform any valuable computation. To overcome this issue, the orchestrator (that schedules the functions for execution) takes care of generating the data streams (or stream segments) (in conjunction with the controller (e.g., 162, FIG. 1.2)) for the pipeline with the correct stream parallelism. That is, before starting any computation, the orchestrator may determine the number of functions to be executed (based on (i) a user-defined limit and/or (ii) the inspection of the input dataset). With this information, the orchestrator (in conjunction with the controller (e.g., 162, FIG. 1.2)) may generate the necessary data streams (or stream segments) for the pipeline and set the correct degree of parallelism accordingly.

In one or more embodiments, the orchestrator may further include functionality to, e.g.,: (i) with the help of the programmatic abstraction, keep/maintain metrics (e.g., in its database) about the processing performance of the serverless functions in a fine-grained manner (e.g., so that a user can act on individual functions, if needed, by scaling up or scaling down the number of functions); (ii) expose/provide one or more policies to users/administrators so that users can define a correct approach (e.g., a user-defined policy/approach) in which both serverless functions and data streams (or stream segments of the data streams) are auto-scaled in a coordinated manner; (iii) monitor serverless functions (e.g., 202A, 206B, etc.) and data streams, and, as a result of the monitoring, takes coordinated auto-scaling decisions (for the functions and/or streams) based on real-time (or near real-time) metrics and user-defined policies; (iv) coordinate auto-scaling of serverless functions with the streaming storage system (including/managing elastic data streams); and/or (v) use the streaming storage system (e.g., 125, FIG. 1.2) as a data-intensive I/O workload channel for serverless functions (e.g., use elastic data streams (of the streaming storage system) to build a coordinated mechanism for auto-scaling stream segments/partitions and serverless function parallelism).

As indicated above, the orchestrator may be responsible for dynamically repartitioning a given elastic data stream (which is used as a data-intensive I/O workload channel for serverless functions/computing) and one or more serverless functions writing and reading data to/from the data stream based on the workload at hand and user-defined “auto-scaling” policies, in order to dynamically align the parallelism of the data stream with the number of serverless functions in a coordinated manner. In order to provide its functionalities, the orchestrator may utilize, at least, the following features of the streaming storage system (e.g., 125, FIG. 1.2): (i) data stream parallelism, (ii) stream transactions, and (iii) reader group checkpoints.

Referring to FIG. 1.2 and regarding (i), data streams may have multiple open stream segments in parallel, both for ingesting and consuming data, in which the number of parallel stream segments in a data stream may automatically grow and shrink over time based on the I/O workload the data stream receives (this allows the orchestrator to modify the parallelism of a given data stream based on the number of serverless functions to be executed, if needed).

Referring to FIG. 1.2 and regarding (ii), the streaming storage system (e.g., 125, FIG. 1.2) may support transactions, in which a serverless function (e.g., a writer) may “batch” up a bunch of events (as a transaction) and commit them as a unit into a data stream.

Referring to FIG. 1.2 and regarding (iii), readers (e.g., serverless functions) may be organized into reader groups, in which a reader group is a named collection of readers (that together perform parallel reads from a given data stream). The streaming storage system (e.g., 125, FIG. 1.2) may provide the ability for an application/component to initiate a checkpoint on a reader group (in order to generate a consistent “point-in-time” persistence of the state of each reader in the reader group, by using a specialized event (e.g., a checkpoint event) to signal each reader to preserve its state). Once a checkpoint has been completed, the application may use the checkpoint to reset all the readers in the reader group to the known consistent state represented/indicated by the checkpoint. The orchestrator may exploit the combination of transactions and reader group checkpoints to provide exactly-once semantics to serverless functions (or serverless function pipelines).

In one or more embodiments, the code that is being executed on serverless functions (e.g., 202A, 204N, etc.) may use/implement a programmatic framework (see FIG. 2.2) for unifying batch and stream computations over data streams. Referring to FIG. 2.1, all the serverless functions report metrics (e.g., computing resource utilization values, I/O workload (indicating the number of events/data that is being consumed), etc.) to the orchestrator. A related user/administrator may define auto-scaling policies (e.g., user-defined policies) to determine when the orchestrator should scale up or down the number of stream segments and serverless functions in a coordinated manner on a per-stage basis (to proactively manage data stream and function parallelism). For example, once a stage of functions is receiving too much workload (e.g., events, data, etc., to process/read) according to the user-defined policy and the metrics reported (by each function), the orchestrator may start a scale-up process to increase the number of serverless functions and the number of stream segments in a coordinated manner.

In one or more embodiments, a user-defined “scaling” policy may include parameters to manage a coordinated behavior of each of, for example, a first serverless function, a second serverless function, and a third serverless function consuming a data stream, in which each of these functions is FaaS function and each function provides a computer-implemented service to a user by processing at least a portion of the data stream ingested by the streaming storage system. Additional details of the policy are described below (e.g., the policy may specify one or more thresholds, a ratio between the number of parallel stream segments and the number of serverless functions in each stage of the pipeline), etc.

In one or more embodiments, the orchestrator may store/keep one or more user-defined “auto-scaling” policies and received/obtained metrics in its database/storage or in an external database, in which, via the programmatic framework (more specifically, via “ScalingPolicy” of the “PipelineManager”), a user may define an “auto-scaling” policy based on, at least, the following parameters (and by capturing the coordinated behavior of serverless functions and data streams so that the user may have control over how the system (e.g., 100, FIG. 1.1) should behave under fluctuating workloads): (i) (a) a threshold with respect to data stream ingestion (e.g., data read/write (I/O)) of a serverless function (and/or a reader group) and (b) a threshold with respect to a computing resource utilization value of a serverless function (and/or a reader group), (ii) a ratio between the number of stream segments and the number of serverless functions, and (iii) stream segment and serverless function scaling up and down speed of the orchestrator.

With respect to (i), the user may define the policy including on one or more thresholds so that the orchestrator may scale up or down the number of stream segments and the number of serverless functions based on the thresholds. With respect to (ii), the user may define the policy including a ratio between the number of stream segments and the number of serverless functions. (e.g., the number of “parallel” stream segments =the number of serverless functions, indicating a “one-to-one” relationship for having a full utilization of the system (e.g., 100, FIG. 1.1)).

One of ordinary skill will appreciate that other ratio scenarios may also be considered without departing from the scope of the embodiments disclosed herein. For example, the user may define a “one-to-four” relationship between the number of parallel stream segments and the number of serverless functions. As yet another example, the user may define a “one-to-two” relationship/ratio between the number of parallel stream segments and the number of serverless functions and thus, the orchestrator may increase (or scale up) the number of serverless functions to allow them to read stream data without having to scale up the number of stream segments (just redistributing the available, existing stream segments).

With respect to (iii), the user may define the policy including stream segment and serverless function scaling up and down speed of the orchestrator. For example, based on the user-defined policy and obtained metrics (from the serverless functions), the orchestrator may decide to generate two more stream segments out of one stream segment (upon a stream segment scaling up event) within a predetermined period of time (for not affecting the overall efficiency of the pipeline).

Turning now to FIG. 2.2, FIG. 2.2 shows an example programmatic framework (e.g., to unify streaming and batch serverless workloads) in accordance with one or more embodiments disclosed herein. The example, illustrated in FIG. 2.2 and described below, is explanatory purposes only and not intended to limit the scope disclosed herein.

Referring to FIG. 2.2, the framework may specify: “//Create a pipeline; Source<byte[]>source=XSource. fromStream(scope, inputStreamName); Pipeline<byte[], float[]>pipeline=source.map(new SimpleTransformer<byte[], float[]>(){@Override public float [] apply(byte[] bytes) {return null;}},1).writeToStream(scope, outputStreamName); //Execute the pipeline PipelineManager manager=new PipelineManager(pipeline, new PravegaJobMonitorFactory(URI.create(“tcp://localhost:9090”)), new StaticScalingPolicy(2), true, true, true); manager.createResources(); manager.execute(); manager.deleteResources(); manager.shutdown();”.

In one or more embodiments, the framework may allow a user/administrator to use a data stream for both batch and streaming serverless analytics. Referring to FIG. 2.2, the framework (or the code that is being executed in each serverless function) provides/encompasses several abstractions to unify streaming and batch analytics for serverless functions when managing data from data streams and to help users generating/building serverless analytics pipelines. For example, in the code, (i) the “source” abstraction/library represents a stream source for a serverless pipeline (where a data stream is considered as a data source), (ii) the “pipeline” abstraction represents a series of serverless computation stages that are pipelined (in a similar way to a dataflow framework), in which each of these computation stages may be of multiple types (e.g., a “mapping” stage (including mapping serverless functions), a “filtering” stage (including filtering serverless functions), a “reduce by key” stage, etc.) and the orchestrator (e.g., the “PipelineManager”) may deploy related logic within each computation stage of the pipeline for efficiency reasons (e.g., while generating intermediate streams that are going to handle read/write processes between different stages); and (iii) the pipeline may be finished with the “writeToStream” abstraction to store the output to a separate stream and/or to the long-term storage.

Referring to FIG. 2.2, the same pipeline may be used/implemented irrespective of the data that is being consumed (e.g., in a streaming fashion, in a batch computation fashion, etc.), in which, with the help of the tiered streaming storage system (e.g., 125, FIG. 1.2), streaming data is served with low-latency whereas cold data can be read with high-throughput and parallelism from the long-term storage (e.g., 140, FIG. 1.2). As indicated above, the framework may abstract the access to data streams (or may provide a stream-based abstraction) from a serverless function's perspective (e.g., the framework may abstract data streams for serverless functions to cope with different types of workloads) and enable defining one or more user-defined auto-scaling policies within the pipeline. The framework may also simplify developmental efforts of users (e.g., expert users, non-expert users, etc.) that use serverless functions by not forcing the users to use a specific API based on the type of the workload/job that needs to be executed (e.g., users can easily execute a batch analytics job or a streaming analytics job on the same data stream without changing an existing API).

FIG. 3 shows a method for managing a data stream processing pipeline (e.g., dynamic auto-scaling of serverless functions and stream segments (of the pipeline) in a coordinated manner) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3, the method shown in FIG. 3 may be executed by, for example, the above-discussed orchestrator (e.g., 127, FIG. 1.1). Other components of the system (100) illustrated in FIG. 1.1 may also execute all or part of the method shown in FIG. 3 without departing from the scope of the embodiments disclosed herein.

In Step 300, the orchestrator monitors data stream ingestion of the streaming storage system (e.g., 125, FIG. 1.1) and a computing resource utilization value of one or more serverless functions (e.g., a first serverless function (that is part of a first stage of a pipeline), a second serverless function (that is part of the first stage of the pipeline), a third serverless function (that is part of a second stage of the pipeline), etc.) of the pipeline (see FIG. 2.1) to obtain/gather a set of metrics (which is the substrate for making decisions on auto-scaling of serverless functions, stream segments/partitions, or both, depending on the user-defined scaling policy and the workload/data that needs to be processed). In one or more embodiments, the set of metrics may include data stream metrics (e.g., associated with one or more SSs, where data stream ingestion represents a bound for an end-to-end data stream processing pipeline, not only in terms of ingestion throughput, but also in terms of read/write parallelism for data processing) and resource related metrics.

In one or more embodiments, data stream metrics may include (or specify), for example (but not limited to): a product identifier of a client (e.g., 110A, FIG. 1.1); a type of a client; a number of elastic data streams received by the streaming storage system (e.g., 125, FIG. 1.2); a number of segment stores being executed on the streaming storage system; a type of data being ingested by the streaming storage system; a degree of parallelism (with respect to elastic data streams supported by the streaming storage system; information with respect to elastic data streams; cost of executing a segment store; segment store configuration information (e.g., a storage size of a segment container (e.g., 165A, FIG. 1.2); an access mode of a segment store, etc.); an identifier of a data item; a size of the data item; an identifier of a user who initiated a data stream (via a client); a user activity performed on a data item; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; a cumulative history of user activity records obtained over a prolonged period of time; a number of the parallel stream segments; a type of OS used by the streaming storage system; a resource utilization value of a resource associated with a segment store; a number of elastic data streams that are consumed by each stage of a pipeline; a number of parallel stream segments that are consumed by each stage of a pipeline; a type of data that is part of a data stream; a number of each type of the data; a size of each type of the data, a type of an OS that is used by the streaming storage system; a number of queued events that are waiting for a serverless function to consume; etc.

In one or more embodiments, resource related metrics (or resource utilization related metrics) (where the programmatic framework (e.g., FIG. 2.2) may keep the internal metrics of related serverless functions) may include (or specify), for example (but not limited to): a type of an asset (e.g., a workload, a file, a folder, etc.) utilized/processed by a serverless function; a product/hardware identifier of a client (e.g., 110A, FIG. 1.1); a type of a client; a type of a file system; computing resource (e.g., CPU, GPU, DPU, memory, network, storage space, storage I/O, etc.) utilization data (e.g., data related to a serverless function's maximum, minimum, and/or average CPU utilizations, an amount of memory utilized by a serverless function, an amount of GPU utilized by a serverless function, etc.) regarding the resources assigned to a serverless function; one or more application logs; one or more system logs; a setting (and a version) of a mission critical application executing on a serverless function; a product identifier of a serverless function; a product configuration information associated with a serverless function; a job detail (e.g., an amount of events read by multiple serverless functions at the same time); a type of a job (e.g., a data protection job, a data restoration job, a non-parallel processing job, a parallel processing job, etc.) that has been initiated; information associated with a hardware resource set of a serverless function; a total number of serverless functions; a garbage collection setting of a serverless function; cost of executing a serverless function; a relationship between a number of parallel stream segments and a number of serverless functions (e.g., a one-to-one relationship, one-to-two relationship, one-to-four relationship, etc.); a backup history documentation of a workload; recently obtained customer/user information (e.g., records, credentials, etc.) of a user; a restore history documentation of a workload; storage size (or capacity) consumed on the long-term storage (e.g., 140, FIG. 1.2) by a related serverless function; a completion timestamp encoding a date and/or time reflective of the successful completion of a workload; a time duration reflecting the length of time expended for executing and completing a workload; a deduplication ratio reflective of the deduplication efficiency of a workload; a backup retention period associated with a workload (e.g., a data stream); a status of a job (e.g., how many jobs are still active, how many jobs are completed, etc.); a number of requests handled (in parallel) per minute (or per second, per hour, etc.) by a serverless function; a number of errors encountered when handling a workload; a health status of a serverless function; a documentation that shows how a related serverless function performs against an SLO and/or an SLA; a set of requests received by a serverless function; a set of responses provided (by the serverless function) to those requests; a number of data (e.g., queued events, elastic data streams, etc.) that needs to processed/consumed by a serverless function; a length of queued events that needs to be consumed by a serverless function; data/event processing speed of a serverless function (e.g., the number of events/bytes that is being processed per-second by the serverless function, the event processing latency of the serverless function, etc.); a processing resource utilization of a serverless function; an amount of network bandwidth utilized by a serverless function; a storage space utilization of a serverless function; etc.

In one or more embodiments, the set of metrics may be obtained via any technique for receiving data, such as, for example, over a network (e.g., 130, FIG. 1.1), manually, etc. The set of metrics may be obtained/received (e.g., from the controller (e.g., 162, FIG. 1.2), from each serverless function (via the programmatic framework (see FIG. 2.2)), etc.) at one time (e.g., on demand), or may be obtained at any number of different times (e.g., periodically) and aggregated to form the set of metrics.

In one or more embodiments, before analyzing (in Step 302) the set of metrics, the orchestrator may store (temporarily or permanently) the metrics in its database. Further, referring to FIG. 1.1, IN A (120A) may host the first serverless function, second serverless function, and third serverless function.

In Step 302, by employing a set of linear, non-linear, and/or ML models (e.g., a reactive model, a proactive model, etc.), the orchestrator analyzes the set of metrics (obtained in Step 300) based on a user-defined scaling policy (specifying, for example, (i) “stream segments =serverless functions”, (ii) a serverless function's resource usage/utilization value <a second threshold (50%) (which specifies generation of an additional serverless function(s) in the corresponding reader group/stage when the serverless function's computing resource utilization value (CRUV) of a computing resource exceeds the second threshold (e.g., a predetermined maximum CRUV threshold value) for a period of time (e.g., for a minute), (iii) segment store write latency<a third threshold (P95<20 ms) (which specifies generation of an additional serverless function(s) in the corresponding reader group/stage when the 95^{th} percentile of an end-to-end write latency exceeds 20 ms), (iv) a serverless function's CRUV>a sixth threshold (5%) (which specifies removal of that serverless function from the corresponding reader stage when the serverless function's CRUV of a computing resource stays below the sixth threshold (e.g., a predetermined minimum CRUV threshold value) for a period of time (e.g., for ten minutes), etc.).

In one or more embodiments, based on the analysis, the orchestrator may, for example (but not limited to): infer information regarding an elastic data stream (e.g., because of the fluctuations in the ingestion workload, a data stream may change the number of parallel segments dynamically), obtain information regarding how serverless functions have been utilized in the end-to-end data stream processing pipeline in order to increase performance and reliability of the stream processing system, obtain information regarding how stream segments have been utilized in the end-to-end data stream processing pipeline, etc.

In Step 304, based on Step 302, the orchestrator makes a first determination (in real-time or near real-time) as to whether data stream ingestion (e.g., of a related serverless function (and/or a reader group)) exceeds the first threshold, a computing resource utilization value of a related serverless function (and/or a reader group) exceeds the second threshold, and/or the segment store write latency exceeds the third threshold. Accordingly, in one or more embodiments, if the result of the first determination is YES (indicating that a corresponding serverless function is struggling/slow/saturated to process/consume a currently assigned event/data (because, compared to other functions in the same stage, this function is previously assigned with too much data at the data stream level)), the method proceeds to Step 306. If the result of the first determination is NO, the method alternatively proceeds to Step 308.

In Step 306, as a result of the first determination in Step 304 being YES (e.g., the data stream ingestion exceeds the first threshold (because of an increased workload of the source data stream (e.g., where the related reader group (and, thus, the third serverless function) consistently receiving a higher amount of data writes)) and the computing resource utilization value of the third serverless function exceeds the second threshold), based on the user-defined scaling policy, and for a better end-to-end data stream processing pipeline management, the orchestrator automatically reacts to (i) initiate increasing (e.g., scaling up) a first number/quantity of stream segments (with the help of their dynamic runtime adaptation feature) of a data stream (e.g., associated with the second stage of the pipeline) executing on the stream processing system (where, for example, a single “hot” stream segment may be split into two “parallel” stream segments (by the controller (e.g., 162, FIG. 1.2))) to support the increased data stream ingestion, to have more I/O (e.g., data read/write) parallelism, and to have more compute power and (ii), based on the above trend in the number of “parallel” stream segments (e.g., in a coordinated manner), initiate increasing (e.g., scaling up) a second number of serverless functions (e.g., associated with the second stage of the pipeline) to reduce the computing resource utilization value of the third serverless function and to have more data processing parallelism. In one or more embodiments, scaling up of the second number of serverless functions may be achieved by deploying another serverless function to the second stage.

For example, referring to FIG. 2.1, the orchestrator may scale up the quantity of serverless functions in “Reader Group M” from two to three (e.g., by adding 206A to Reader Group M, illustrated by a half dashed dotted box), in parallel to the change in the number of stream segments (illustrated by a half dashed dotted box including at least event 0 (e0)). Thereafter, the method returns to Step 300 in order to continuously monitor the end-to-end data stream processing pipeline, analyze the metrics, and react accordingly (where all the steps are transparent to the end-users).

As indicated above, data streams are elastic, which means the streams may automatically change their degree of parallelism based on an ingestion workload, and users of the system (e.g., 100, FIG. 1.1) may change the scaling policies, at least, with respect to data streams based on events/bytes per-second.

In Step 308, as a result of the first determination in Step 304 being NO (e.g., the data stream ingestion does not exceed the first threshold and the computing resource utilization value of the second serverless function does not exceed the second threshold), the orchestrator makes a second determination (in real-time or near real-time) as to whether data stream ingestion (e.g., of a related serverless function (and/or a reader group), of the second serverless function, etc.) is below a fifth threshold and the computing resource utilization value of the related function (e.g., the second serverless function) is below the sixth threshold. Accordingly, in one or more embodiments, if the result of the second determination is YES, the method proceeds to Step 310. If the result of the second determination is NO, the method alternatively ends.

In Step 310, as a result of the second determination in Step 308 being YES, based on the user-defined scaling policy, and for a better end-to-end data stream processing pipeline management, the orchestrator automatically reacts to (i) initiate decreasing (e.g., scaling down) a first number/quantity of stream segments (with the help of their dynamic runtime adaptation feature) of a data stream (e.g., associated with the first stage of the pipeline) executing on the stream processing system (where, for example, four “cold” stream segment may be merged into two stream segments (by the controller) to support the reduced data stream ingestion, to have less I/O parallelism, and to have less compute power and (ii), based on the above trend in the number of “parallel” stream segments (e.g., in a coordinated manner), initiate decreasing (e.g., scaling down) a second number of serverless functions (e.g., associated with the first stage of the pipeline, by removing the second serverless function from the first stage) to support a reduced computing resource utilization value of the second serverless function. Thereafter, the method returns to Step 300 in order to continuously monitor the end-to-end data stream processing pipeline, analyze the metrics, and react accordingly (where all the steps are transparent to the end-users).

Turning now to FIG. 4, FIG. 4 shows a diagram of a computing device in accordance with one or more embodiments disclosed herein.

In one or more embodiments disclosed herein, the computing device (400) may include one or more computer processors (402), non-persistent storage (404) (e.g., volatile memory, such as RAM, cache memory), persistent storage (406) (e.g., a non-transitory computer readable medium, a hard disk, an optical drive such as a CD drive or a DVD drive, a Flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (e.g., a LAN, a WAN, Internet, mobile network, etc.) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a data stream processing pipeline, the method comprising:
monitoring data stream ingestion of a streaming storage system (SSS) and a computing resource utilization value (CRUV) of each of a first serverless function (SF), a second SF, and a third SF to obtain a set of metrics,
wherein the first SF and the second SF are part of a first stage of the pipeline and the third SF is part of a second stage of the pipeline,
wherein a node comprises the first SF, the second SF, and the third SF, wherein the node and the SSS communicate over a network and form the pipeline;
analyzing the set of metrics based on a user-defined scaling policy;
making, based on the analyzing, a determination that the data stream ingestion exceeds a first threshold and the CRUV of the third SF exceeds a second threshold;
in response to the determination:
initiating scaling up of a first number of stream segments of a data stream associated with the second stage; and
initiating scaling up of a second number of SFs associated with the second stage to reduce the CRUV of the third SF, wherein the scaling up of the second number of SFs is achieved by deploying a fourth SF to the second stage.

2. The method of claim 1, wherein the first stage and the second stage are connected by the data stream, wherein each of the first stage and the second stage represents a reader group that consumes data from the data stream.

3. The method of claim 2, wherein the data stream is a continuous, unbounded, append-only, and durable sequence of bytes and wherein a controller of the SSS manages the data stream.

4. The method of claim 3, wherein the SSS comprises a tier-1 storage, wherein the tier-1 storage is a distributed write ahead log providing short-term, durable, and low-latency data protection of the data stream, wherein the SSS is operatively connected to a tier-2 storage, and wherein the tier-2 storage is a pluggable object storage providing long-term and durable data protection of the data stream.

5. The method of claim 1, wherein the user-defined scaling policy comprises parameters to manage a coordinated behavior of each of the first SF, the second SF, and the third SF with the data stream, wherein each of the first SF, the second SF, and the third SF is a Function-as-a-Service (FaaS) function, and wherein the third SF provides a computer-implemented service to a user by processing at least a portion of the data stream ingested by the SSS.

6. The method of claim 1, wherein the user-defined scaling policy specifies the first threshold and the second threshold, and wherein the user-defined scaling policy further specifies a one-to-two ratio between a first quantity of parallel stream segments and a second quantity of SFs in each stage of the pipeline.

7. The method of claim 1, wherein the set of metrics comprises data stream metrics and resource related metrics.

8. The method of claim 7, wherein the data stream metrics specify at least one selected from a group consisting of a number of elastic data streams that are consumed by each stage of the pipeline, a number of parallel stream segments that are consumed by each stage of the pipeline, a type of data that is part of the data stream, a number of each type of the data, a size of each type of the data, a type of an operating system that is used by the SSS, and a number of queued events that are waiting for the third SF to consume.

9. The method of claim 7, wherein the resource related metrics specify at least one selected from a group consisting of a processing resource utilization of the first SF, an event processing speed of the first SF, an amount of network bandwidth utilized by the second SF, an event processing speed of the second SF, a storage space utilization of the third SF, and an event processing speed of the third SF.

10. A method for managing a data stream processing pipeline, the method comprising:
monitoring data stream ingestion of a streaming storage system (SSS) and computing resource utilization value (CRUV) of each of a first serverless function (SF), a second SF, and a third SF to obtain a set of metrics,
wherein the first SF and the second SF are part of a first stage of the pipeline and the third SF is part of a second stage of the pipeline,
wherein a node comprises the first SF, the second SF, and the third SF, wherein the node and the SSS communicate over a network and form the pipeline;
analyzing the set of metrics based on a user-defined scaling policy;
making, based on the analyzing, a first determination that the data stream ingestion does not exceed a first threshold and the CRUV of the second SF does not exceed a second threshold;
making, based on the first determination, a second determination that the data stream ingestion is less than a third threshold and the CRUV of the second SF is less than a fourth threshold;
in response to the second determination:
initiating scaling down of a first number of stream segments of a data stream associated with the first stage; and
initiating scaling down of a second number of SFs associated with the first stage to support a reduced CRUV of the second SF.

11. The method of claim 10, wherein the first stage and the second stage are connected by the data stream, wherein each of the first stage and the second stage represents a reader group that consumes data from the data stream.

12. The method of claim 11, wherein the data stream is a continuous, unbounded, append-only, and durable sequence of bytes and wherein a controller of the SSS manages the data stream.

13. The method of claim 12, wherein the SSS comprises a tier-1 storage, wherein the tier-1 storage is a distributed write-ahead log providing short-term, durable, and low-latency data protection of the data stream, wherein the SSS is operatively connected to a tier-2 storage, and wherein the tier-2 storage is a pluggable object storage providing long-term and durable data protection of the data stream.

14. The method of claim 10, wherein the user-defined scaling policy comprises parameters to manage a coordinated behavior of each of the first SF, the second SF, and the third SF with the data stream, wherein each of the first SF, the second SF, and the third SF is a Function-as-a-Service (FaaS) function, and wherein the third SF provides a computer-implemented service to a user by processing at least a portion of the data stream ingested by the SSS.

15. The method of claim 10, wherein the user-defined scaling policy specifies the first threshold and the second threshold, and wherein the user-defined scaling policy further specifies a one-to-two ratio between a first quantity of parallel stream segments and a second quantity of SFs in each stage of the pipeline.

16. The method of claim 10, wherein the set of metrics comprises data stream metrics and resource related metrics.

17. The method of claim 16, wherein the data stream metrics specify at least one selected from a group consisting of a number of elastic data streams that are consumed by each stage of the pipeline, a number of parallel stream segments that are consumed by each stage of the pipeline, a type of data that is part of the data stream, a number of each type of the data, a size of each type of the data, a type of an operating system that is used by the SSS, and a number of queued events that are waiting for the third SF to consume.

18. The method of claim 16, wherein the resource related metrics specify at least one selected from a group consisting of a processing resource utilization of the first SF, an event processing speed of the first SF, an amount of network bandwidth utilized by the second SF, an event processing speed of the second SF, a storage space utilization of the third SF, and an event processing speed of the third SF.

19. A non-transitory computer readable medium comprising computer readable program code, which when executed by a computer processor enables the computer processor to perform a method for managing a data stream processing pipeline, the method comprising:
monitoring data stream ingestion of a streaming storage system (SSS) and computing resource utilization value (CRUV) of each of a first serverless function (SF), a second SF, and a third SF to obtain a set of metrics,
wherein the first SF and the second SF are part of a first stage of the pipeline and the third SF is part of a second stage of the pipeline,
wherein a node comprises the first SF, the second SF, and the third SF, wherein the node and the SSS communicate over a network and form the pipeline;
analyzing the set of metrics based on a user-defined scaling policy;
making, based on the analyzing, a determination that the data stream ingestion exceeds a first threshold and the CRUV of the third SF exceeds a second threshold;
in response to the determination:
initiating scaling up of a first number of stream segments of a data stream associated with the second stage; and
initiating scaling up of a second number of SFs associated with the second stage to reduce the CRUV of the third SF, wherein the scaling up of the second number of SFs is achieved by deploying a fourth SF to the second stage.

20. The non-transitory computer readable medium of claim 19, wherein the first stage and the second stage are connected by the data stream, wherein each of the first stage and the second stage represents a reader group that consumes data from the data stream.
